(19) United States
(12) Patent Application Publication
(10) Pub. No.: US 2004/0259751 A1
(43) Pub. Date: Dec. 23, 2004

(54) Dosed washing and cleaning agent composition

(76) Inventors: Arnd Kessler, Monheim (DE); Rolf Bayersdorfer, Dusseldorf (DE); Christian Nitsch, Dusseldorf (DE); Alexander Lambotte, Koln (DE); Michael Dreja, Koln (DE)

Correspondence Address: WOODCOCK WASHBURN LLP, ONE LIBERTY PLACE, 46TH FLOOR, PHILADELPHIA, PA, 19103, US

(21) Appl. No.: 10/861,211

(22) Filed: Jun. 4, 2004

Related U.S. Application Data
(63) Continuation of application No. PCT/EP02/13286, filed on Nov. 26, 2002.

(30) Foreign Application Priority Data
Dec. 5, 2001 (DE) 10159780.0

(51) Int. Cl. C11D 17/00

(52) U.S. Cl. 510/293

(57) ABSTRACT

The present invention relates to a dosed liquid washing and cleaning agent composition, comprising a non-aqueous matrix and solid particles dispersed therein, in a bag made from a water-soluble film. Whereby at least 70 wt. % of the particles of the washing and cleaning agent composition comprise particle sizes below 200 μm. By means of the selection of said particle size range for the suspended particles, normally occurring production problems of leakage of the bag seams and the resulting problems may be avoided.

### CROSS REFERENCE TO RELATED APPLICATIONS

This application is a continuation of PCT/EP02/13286, filed Nov. 26 2002, which claims the benefit of DE 10159780.0 filed Dec. 5, 2001.

### FIELD OF INVENTION

The present invention relates to dosed washing and cleaning agent compositions which make it easier for the consumer to dose washing and cleaning agents. In particular, the invention relates to dosed washing and cleaning agent compositions which are packaged in a bag made of water-soluble film and are referred to for short as “portion bags”.

### BACKGROUND

Washing and cleaning agents and also processes for their preparation are well-known and consequently described widely in the prior art. Usually, they are made available to the consumer in the form of spray-dried or granulated powder products or in the form of liquid goods. In response to the consumer's desire for easier dosing, besides these two classical variants, products in predosed form have become established in the market place and are likewise described comprehensively in the prior art, where, in particular, compressed moldings, i.e. tablets, blocks, briquettes and the like, and portions of solid or liquid washing and cleaning agents packaged in bags are described.

In the case of the individual dose amounts of washing and cleaning agents which are commercially available packaged in bags, bags made of water-soluble film have become accepted, which make it unnecessary for the consumer to tear the package open. This permits simple dosing of an individual portion by placing the bag directly into the washing machine or dishwasher, or into their detergent compartments, or by adding to a predetermined amount of water, for example in a bucket or in a handwashing basin or sink. Consequently, washing and cleaning agents packaged in bags made of water-soluble film are described in large numbers in the prior art.

For example, DE-B 1130547 (Procter & Gamble) discloses packages of water-soluble films of polyvinyl alcohol which are filled with non-liquid synthetic washing agents. The particle sizes of the packaged washing agents is not discussed in this specification.

An individual dose of a washing agent or bleach in a bag which has one or more seams made of water-sensitive material is described in European patent application EP 143 476 (Akzo N.V.). The water-sensitive seam material proposed in this publication is a mixture of anionic and/or nonionic water-binding polymer and a cationic polymer paste.

Extremely large particles which are surrounded by a water-insoluble film are described in EP 385 529 (Procter & Gamble). This specification discloses a jumbo-particulate textile softener composition whose 5 to 30 mm-sized dryer-activated softener particles are surrounded by a non-water-soluble, porous film.

It has been found that problems arise relating to the production of washing and cleaning agent compositions packaged in portion bags of the prior art. Upon packaging the washing and cleaning agent compositions into the water-soluble film, fine particles remain stuck to the film and pass into the seam forming the bag as the film is sealed to give the sealed bag. As a result of these particles in the seal, the seams in question are not completely tight toward the atmosphere, which can lead to problems relating to the stability of the washing and cleaning agent composition.

To solve these problems, DE 198 31 703 (Henkel KGaA) has proposed that at least 70% by weight of the particles of the washing and cleaning agent composition have particle sizes above 800 μm.

None of said specifications discloses liquid washing or cleaning agent compositions packaged in so-called pouches. It has been found that similar problems arise here as with particulate compositions: the liquid washing or cleaning agent composition to be packaged in the bags often drips or has stringy properties, meaning that, as the bags are sealed, these strings or drips and thus product residues pass into the seam where—as described above, they lead to leaks which have much more disastrous consequences for liquid contents than for particulate contents. In the case of liquid washing or cleaning agent compositions, it may additionally be the case that the drops or product strings which are enclosed in the seam to be formed are subjected to such thermal stress when a hot-sealing method is used that the composition boils and may lead to further leaks, discolorations or, in the most serious case, even to accidents as a result of thermal decomposition.

Interestingly, changing the viscosity of the liquid washing or cleaning agent composition does not lead to success; it must instead be supported by suitable further measures during product formulation, these measures leading to improved results also irrespectively of the viscosity of the agent.

### SUMMARY

The avoidance of these problems and the provision of a dosed liquid, i.e. pourable, washing or cleaning agent composition in which the seams of the bags consisting of water-soluble film are tight toward the atmosphere was an object of the present invention. It was shown that said problems of non-tight seams and the subsequent problems resulting therefrom can be excluded if the liquid washing and cleaning agent compositions to be dosed satisfy certain criteria with regard to the particle size of the particles suspended in the liquid solvent matrix.

The invention therefore provides a dosed liquid washing or cleaning agent composition in a bag made of water-soluble film, comprising a nonaqueous matrix and solid particles dispersed therein, where at least 70% by weight of the dispersed solid particles have particle sizes below 200 μm.

### DETAILED DESCRIPTION

In one embodiment, the present invention describes a portion bag, comprising a liquid washing or cleaning agent composition comprising solid particles dispersed in a nonaqueous matrix, wherein at least 70% by weight of the dispersed solid particles have particle sizes below 200 μm, and a water-soluble film enclosing the liquid washing or cleaning agent composition.

With said particle size range, the problems of sealing remaining drops or liquid strings into the seam no longer arise. In this connection, the at least 70% by weight of the particles and the 200 μm are to be understood as meaning upper limits which result, for example, from the fact that, for technical reasons, solids used can also comprise small amounts of coarse fractions. However, within the scope of the present invention, it is preferred to have the highest possible fraction and a fraction significantly more than 70% by weight, of particles with sizes below 200 μm in the washing and cleaning agent composition. A fraction of particularly fine particles whose particle sizes are significantly below 200 μm will likewise be advantageous. Preferred dosed washing or cleaning agent compositions have at least 50% by weight, preferably at least 55% by weight, particularly preferably at least 60% by weight and in particular at least 70% by weight, of the dispersed solid particles with particle sizes between 1 and 200 μm, preferably between 5 and 160 μm, particularly preferably between 7.5 and 120 μm and in particular between 10 and 100 μm.

The liquid washing or cleaning agent compositions according to the invention which are packaged in the bags made of water-soluble film may be of low viscosity to high viscosity. For the purposes of the present invention, “liquid” characterizes agents which are flowable at room temperature and can run out of containers under the action of gravity. As already mentioned above, the viscosity of the washing or cleaning agent compositions does not play the decisive role in solving the problems of after-dripping and stringing, and leaks in bag seams resulting therefrom. The advantages of the agents according to the invention with regard to solving the described problems, however, can be further extended if the viscosity of the agents is in certain ranges. In this regard, particular preference is given to dosed washing or cleaning agent compositions according to the invention in which the liquid washing or cleaning agent composition has a viscosity (Brookfield viscometer LVT-II at 20 rpm and 20° C., spindle 3) of from 500 to 50 000 mPas, preferably from 1000 to 10 000 mPas, particularly preferably from 1200 to 5000 mPas and in particular from 1300 to 3000 mPas.

The agents according to the invention are packaged in bags made of water-soluble film. This means that the washing or cleaning agent composition present in the bags must only have a certain water content since otherwise the bag material would start to dissolve. On the other hand, a certain lower content of water in the washing or cleaning agent compositions is advantageous since a completely anhydrous and possibly hygroscopic composition could otherwise “dry out” the bag. Depending on the bag materials and the other ingredients in the washing or cleaning agent composition, water contents according to the invention between 0.1 and 6% by weight, preferably between 0.5 and 5% by weight and in particular between 1 and 4% by weight, in each case based on the washing or cleaning agent composition, have proven to be advantageous.

The agents according to the invention are in the form of solid suspension in a nonaqueous solvent. These nonaqueous solvents originate, for example, from the groups of monoalcohols, diols, triols and/or polyols, ethers, esters and/or amides. In this regard, particular preference is given to nonaqueous solvents which are water-soluble, where “water-soluble” solvents for the purposes of the present application are solvents which are completely miscible, i.e. without miscibility gaps, with water at room temperature.

Nonaqueous solvents which can be used in the agents according to the invention preferably originate from the group of mono- or polyhydric alcohols, alkanolamines or glycol ethers provided they are miscible with water in the stated concentration range. The solvents are preferably chosen from ethanol, n- or i-propanol, butanols, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxylethoxy-2-propanol, 3-methyl-3-methoxybutanol, propylene glycol t-butyl ether, and mixtures of these solvents.

A dosed washing or cleaning agent composition particularly preferred for the purposes of the present invention is characterized in that it comprises nonaqueous solvent(s) in amounts of from 0.1 to 70% by weight, preferably from 0.5 to 60% by weight, particularly preferably from 1 to 50% by weight, very particularly preferably from 2 to 40% by weight and in particular from 2.5 to 30% by weight, in each case based on the total composition, where preferred nonaqueous solvent(s) is/are chosen from the group of nonionic surfactants which are liquid at room temperature, of polyethylene glycols and polypropylene glycols, glycerol, glycerol carbonate, triacetin, ethylene glycol, propylene glycol, propylene carbonate, hexylene glycol, ethanol, and n-propanol and/or isopropanol.

The nonionic surfactants liquid at room temperature are described in detail below as washing- or cleaning-active substances.

Polyethylene glycols (abbreviation PEG) which can be used according to the invention are liquid at room temperature. PEGs are polymers of ethylene glycol which satisfy the general formula (I)

H—(O—CH₂—CH₂)ₙ—OH (I)

where n can assume values between 1 (ethylene glycol, see below) and about 16. For polyethylene glycols, there are various nomenclatures, which can lead to confusion. It is common practice in industry to state the average relative molecular weight after “PEG”, meaning that “PEG 200” characterizes a polyethylene glycol with a relative molar mass of from about 190 to about 210. According to this nomenclature, the industrially conventional polyethylene glycols PEG 200, PEG 300, PEG 400 and PEG 600 can be used within the scope of the present invention.

For cosmetic ingredients, a different nomenclature is used in which the abbreviation PEG is given a hyphen and directly after the hyphen a number follows which corresponds to the number n in the abovementioned formula. According to this nomenclature (so-called INCI nomenclature, CTFA International Cosmetic Ingredient Dictionary and Handbook, 5th edition, The Cosmetic, Toiletry and Fragrance Association, Washington, 1997), PEG-4, PEG-6, PEG-8, PEG-9, PEG-10, PEG-12, PEG-14 and PEG-1 6, for example, according to the invention can be used according to the invention.

Commercially available polyethylene glycols are, for example, those under the trade names Carbowax® PEG 200 (Union Carbide), Emkapol® 200 (ICI Americas), Lipoxol® 200 MED (Hüls America), Polyglycol® E-200 (Dow Chemical), Alkapol® PEG 300 (Rhone-Poulenc), Lutrol® E300 (BASF), and the corresponding trade names with higher numbers.

Polypropylene glycols (abbreviation PPG) which can be used according to the invention are polymers of propylene glycol which satisfy the general formula (II)

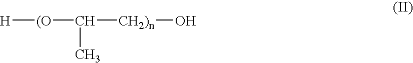

where n can assume values between 1 (propylene glycol, see below) and about 12. Of technical importance here are, in particular, di-, tri- and tetrapropylene glycol, i.e. the representatives where n=2, 3 and 4 in the above formula.

Glycerol is a colorless, clear, not very mobile, odorless, sweet-tasting hygroscopic liquid with a density of 1.261, which solidifies at 18.2° C. Originally glycerol was synthesized only as a by-product of fat hydrolysis, but is nowadays synthesized industrially in large amounts. Most industrial processes start from propene, which is processed via the intermediates allyl chloride and epichlorohydrin to give glycerol. Another industrial process is the hydroxylation of allyl alcohol with hydrogen peroxide over a WO₃ catalyst via the glycide stage.

Glycerol carbonate is accessible by means of transesterification of ethylene carbonate or dimethyl carbonate with glycerol, with ethylene glycol and/or methanol being formed as by-products. A further synthesis route starts from glycidol (2,3-epoxy-1-propanol), which is reacted with CO₂ under pressure in the presence of catalysts to give glycerol carbonate. Glyceryl carbonate is a clear, readily mobile liquid with a density of 1.398 gcm⁻³ which boils at 125-130° C. (0.15 mbar).

Ethylene glycol (1,2-ethanediol, “glycol”) is a colorless, viscous, sweet-tasting, highly hygroscopic liquid which is miscible with water, alcohols and acetone and has a density of 1.113. The solidification point of ethylene glycol is −11.5° C., the liquid boils at 198° C. In industry, ethylene glycol is obtained from ethylene oxide by heating with water under pressure. Promising preparation methods are also based on the acetoxylation of ethylene and subsequent hydrolysis or on synthesis gas reactions.

There are two isomers of propylene glycol, 1,3-propanediol and 1,2-propanediol. 1,3-Propanediol (trimethylene glycol) is a neutral, colorless and odorless, sweet-tasting liquid with a density of 1.0597, which solidifies at −32° C. and boils at 214° C. 1,3-Propanediol is prepared from acrolein and water with subsequent catalytic hydrogenation.

Of considerably more importance in industrial terms is 1,2-propanediol (propylene glycol), which is an oily, colorless, virtually odorless liquid, which has a density of 1.0381 and which solidifies at −60° C. and boils at 188° C. 1,2-Propanediol is prepared from propylene oxide by an addition reaction of water.

Propylene carbonate is a clear, readily mobile liquid with a density of 1.21 gcm⁻³, the melting point is −49° C., the boiling point is 242° C. Propylene carbonate is also obtainable industrially by reacting propylene oxide and CO₂ at 200° C. and 80 bar.

In one or more of the abovementioned or other nonaqueous solvents are suspended solids of the particle size according to the invention. These solids can originate, for example, from the groups of builders, cobuilders, polymers, bleaches, bleach activators, silver protectants, optical brighteners, etc. Preference is given to builders of the main constituent of the suspended solids phase.

Builders are used in the compositions according to the invention primarily for binding calcium and magnesium. Customary builders which may be present within the scope of the invention for example in amounts of from 22.5 to 45% by weight, preferably from 25 to 40% by weight and in particular from 27.5 to 35% by weight, in each case based on the total agent, are the low molecular weight polycarboxylic acids and their salts, the homopolymeric and copolymeric polycarboxylic acids and their salts, the carbonates, phosphates and sodium and potassium silicates. For the cleaning agents according to the invention, preference is given to using trisodium citrate and/or pentasodium tripolyphosphate and silicatic builders from the class of alkali metal disilicates. In general, in the case of the alkali metal salts, the potassium salts are preferred over the sodium salts since they often have a greater solubility in water. Preferred water-soluble builders are, for example, tripotassium citrate, potassium carbonate and the potassium waterglasses.

Particularly preferred machine dishwashing agents comprise, as builders, phosphates, preferably alkali metal phosphates, particularly preferably pentasodium or pentapotassium triphosphate (sodium or potassium tripolyphosphate).

Alkali metal phosphates is the collective term for the alkali metal (in particular sodium and potassium) salts of the various phosphoric acids, among which metaphosphoric acids (HPO₃)ₙ and orthophosphoric acid H₃PO₄, besides higher molecular weight representatives, may be differentiated. The phosphates combine a number of advantages: they act as alkali carriers, prevent limescale deposits and additionally contribute to the cleaning performance.

Sodium dihydrogenphosphate, NaH₂PO₄, exists as the dihydrate (density 1.91 gcm⁻³, melting point 60°) and as the monohydrate (density 2.04 gcm⁻³). Both salts are white powders which are very readily soluble in water, which lose the water of crystallization upon heating and undergo conversion at 200° C. to the weakly acidic diphosphate (disodium hydrogendiphosphate, Na₂H₂P₂O₇), at a higher temperature to sodium trimetaphosphate (Na₃P₃O₉) and Maddrell's salt (see below). NaH₂PO₄ is acidic; it is formed if phosphoric acid is adjusted to a pH of 4.5 using sodium hydroxide solution and the slurry is sprayed. Potassium dihydrogenphosphate (primary or monobasic potassium phosphate, potassium biphosphate, PDP), KH₂PO₄, is a white salt of density 2.33 gcm⁻³, has a melting point of 253° [decomposition with the formation of potassium polyphosphate (KPO₃)ₓ] and is readily soluble in water.

Disodium hydrogenphosphate (secondary sodium phosphate), Na₂HPO₄, is a colorless, very readily water-soluble crystalline salt. It exists in anhydrous form and with 2 mol of water (density 2.066 gcm⁻³, water loss at 95°), 7 mol of water (density 1.68 gcm⁻³, melting point 48° with the loss of 5 H₂O) and 12 mol of water (density 1.52 gcm⁻³, melting point 35° with loss of 5 H₂O), becomes anhydrous at 100° and converts to the diphosphate Na₄P₂O₇ upon more severe heating. Disodium hydrogenphosphate is prepared by neutralizing phosphoric acid with soda solution using phenolphthalein as indicator. Dipotassium hydrogenphosphate (secondary or dibasic potassium phosphate), K₂HPO₄, is an amorphous white salt which is readily soluble in water.

Trisodium phosphate, tertiary sodium phosphate, Na₃PO₄, are colorless crystals which as the dodecahydrate have a density of 1.62 gcm⁻³ and a melting point of 73-76° C. (decomposition), as the decahydrate (corresponding to 19-20% of P₂O₅) have a melting point of 100° C. An in anhydrous form (corresponding to 39-40% of P₂O₅) have a density of 2.536 gcm⁻³. Trisodium phosphate is readily soluble in water with an alkaline reaction and is prepared by evaporative concentration of a solution of exactly 1 mol of disodium phosphate and 1 mol of NaOH. Tripotassium phosphate (tertiary or tribasic potassium phosphate), K₃PO₄, is a white, deliquescent, granular powder of density 2.56 gcm⁻³, has a melting point of 1340° and is readily soluble in water with an alkaline reaction. It is produced, for example, when Thomas slag is heated with charcoal and potassium sulfate. Despite the relatively high price, the more readily soluble and therefore highly effective potassium phosphates are often preferred in the detergents industry over the corresponding sodium compounds.

Tetrasodium diphosphate (sodium pyrophosphate), Na₄P₂O₇, exists in anhydrous form (density 2.534 gcm⁻³, melting point 988°, 880° also reported) and as the decahydrate (density 1.815-1.836 gcm⁻³, melting point 94° with loss of water). Both substances are colorless crystals which are soluble in water with an alkaline reaction. Na₄P₂O₇ is formed when disodium phosphate is heated at >2000 or by reacting phosphoric acid with soda in the stoichiometric ratio and dewatering the solution by spraying. The decahydrate complexes heavy metal salts and water hardness constituents and therefore reduces the hardness of the water. Potassium diphosphate (potassium pyrophosphate), K₄P₂O₇, exists in the form of the trihydrate and is a colorless, hygroscopic powder with a density of 2.33 gcm⁻³ which is soluble in water, the pH of the 1% strength solution at 25° being 10.4.

Condensation of the NaH₂PO₄ or of the KH₂PO₄ gives rise to higher molecular weight sodium and potassium phosphates, among which it is possible to differentiate between cyclic representatives, the sodium and potassium metaphosphates, and catonated types, the sodium and potassium polyphosphates. For the latter, in particular, a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate) is a nonhygroscopic, white, water-soluble salt which is anhydrous or crystallizes with 6 H₂O and has the general formula NaO—[P(O)(ONa)—O]ₙ—Na where n=3. About 17 g of the anhydrous salt dissolve in 100 g of water at room temperature, about 20 g dissolve at 60°, and about 32 g dissolve at 100°; after heating the solution for two hours at 100°, about 8% orthophosphate and 15% diphosphate are produced by hydrolysis. In the case of the preparation of pentasodium triphosphate, phosphoric acid is reacted with soda solution or sodium hydroxide solution in the stoichiometric ratio and the solution is dewatered by spraying. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is commercially available, for example, in the form of a 50% strength by weight solution (>23% P₂O₅, 25% K₂O₁₀). The potassium polyphosphates are widely used in the detergent and cleaners industry.

Preferred machine dishwashing detergents comprise 20 to 60% by weight of one or more water-soluble builders, preferably citrates and/or phosphates, preferably alkali metal phosphates, particularly preferably pentasodium or pentapotassium triphosphate (sodium or potassium tripolyphosphate).

In preferred embodiments of the present invention, the content of water-soluble builders in the agents is within narrow limits. Preference is given here to machine dishwashing agents which comprise the water-soluble builder(s) in amounts of from 22.5 to 55% by weight, preferably from 25 to 50% by weight and in particular from 27.5 to 45% by weight, in each case based on the total agent.

The agents according to the invention can particularly advantageously comprise condensed phosphates as water-softening substances. These substances form a group of phosphates—due to their preparation also called melt or high-temperature phosphates—which can be derived from acidic salts of orthophosphoric acid (phosphoric acids) by condensation. The condensed phosphates can be divided into the metaphosphates [Mln(PO₃)ₙ] and polyphosphates (Mₙ₊₂¹PₙO₃ₙ₊₁ or Mₙ¹H₂PₙO₃ₙ₊₁).

The term “metaphosphates” was originally the general name for condensed phosphates of the composition Mₙ[PₙO₃ₙ] (M=monovalent metal), but is nowadays mostly restricted to salts with ring-shaped cyclo(poly)phosphate anions. When n=3, 4, 5, 6 etc., the terms used are tri-, tetra-, penta-, hexa-metaphosphates etc. According to the systematic nomenclature of isopolyanions, the anion where n=3, for example, is referred to as cyclo-triphosphate.

Metaphosphates are obtained as accompanying substances of Graham's salt—incorrectly referred to as sodium hexametaphosphate—by melting NaH₂PO₄ to temperatures above 620° C., where so-called Maddrell's salt also forms as an intermediate. This and Kurrol's salt are linear polyphosphates which are nowadays mostly not referred to as metaphosphates, but which can likewise be preferably used as water-softening substances for the purposes of the present invention.

The crystalline, water-insoluble Maddrell's salt, (NaPO₃)ₓ where x is >1000, which can be obtained at 200-300° C. from NaH₂PO₄, converts at about 600° C. to the cyclic metaphosphate [Na₃(PO₃)₃], which melts at 620° C. Depending on the reaction conditions, the quenched, glassy melt is the water-soluble Graham's salt, (NaPO₃)₄₀₋₅₀, or a glassy condensed phosphate of the composition (NaPO₃)₁₅₋₂₀, which is known as Calgon. For both products the incorrect name hexametaphosphates is still in use. The so-called Kurrol's salt, (NaPO₃)ₙ where n is≧5000, likewise arises from the 600° C.-hot melt of the Maddrell's salt if this is left for a short time at about 500° C. It forms highly polymeric water-soluble fibers.

Particularly preferred water-softening substances from the abovementioned classes of condensed phosphates which have proven successful are the “hexametaphosphates” Budit® H6 and H8 from Budenheim.

In summary, particularly preferred dosed washing or cleaning agent composition are characterized in that the dispersed solid particles comprise one or more water-soluble builders, preferably citrates and/or phosphates, preferably alkali metal phosphates, particularly preferably pentasodium or pentapotassium triphosphate (sodium or potassium tripolyphosphate), preference being given to compositions which comprise said dispersed solids in amounts of from 5 to 70% by weight, preferably from 10 to 65% by weight, particularly preferably from 15 to 60% by weight, very particularly preferably from 20 to 55% by weight and in particular from 25 to 50% by weight, in each case based on the total composition.

Besides the nonaqueous liquid phase and the builders suspended therein, further ingredients may be present in the washing or cleaning compositions according to the invention. The next most important class of substance in terms of amount to be mentioned here is that of the surfactants, with nonionic surfactants being of prominent importance.

The nonionic surfactants used are preferably alkoxylated, advantageously ethoxylated, in particular primary alcohols having preferably 8 to 18 carbon atoms and on average 1 to 12 mol of ethylene oxide (EO) per mole of alcohol in which the alcohol radical may be linear or methyl-branched preferably in the 2 position, or may contain a mixture of linear and methyl-branched radicals, as are usually present in oxo alcohol radicals. However, particular preference is given to alcohol ethoxylates with linear radicals of alcohols of natural origin having 12 to 18 carbon atoms, e.g. of coconut, palm, tallow fatty or oleyl alcohol, and on average 2 to 8 EO per mole of alcohol. Preferred ethoxylated alcohols include, for example, C₁₂₋₁₄-alcohols having 3 EO or 4 EO, C₉₋₁₁-alcohol with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, such as mixtures of C₁₂₋₁₄-alcohol with 3 EO and C₁₂₋₁₈-alcohol with 5 EO. The given degrees of ethoxylation are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO. Examples thereof are tallow fatty alcohol with 14 EO, 25 EO, 30 EO or 40 EO.

In addition, further nonionic surfactants which may be used are also alkyl glycosides of the general formula RO(G)ₓ, in which R is a primary straight-chain or methyl-branched, in particular methyl-branched in the 2 position, aliphatic radical having 8 to 22, preferably 12 to 18, carbon atoms and G is the symbol which is a glycose unit having 5 or 6 carbon atoms, preferably glucose. The degree of oligomerization x, which gives the distribution of monoglycosides and oligoglycosides, is any number between 1 and 10; preferably, x is 1.2 to 1.4.

A further class of preferably used nonionic surfactants, which are used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain.

Nonionic surfactants of the amine oxide type, for example N-cocoalkyl-N,N-dimethylamine oxide and N-tallow-alkyl-N,N-hydroxyethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula (III),

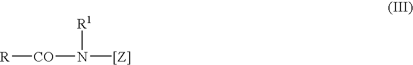

in which RCO is an aliphatic acyl radical having 6 to 22 carbon atoms, R¹ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the formula (IV),

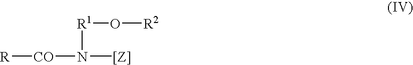

in which R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxy-alkyl radical having 1 to 8 carbon atoms, where C₁₋₄-alkyl or phenyl radicals are preferred and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

The preferred surfactants used are weakly foaming nonionic surfactants. With particular preference, the machine dishwashing agents according to the invention comprise a nonionic surfactant which has a melting point above room temperature. Accordingly, preferred agents are characterized in that they comprise nonionic surfactant(s) with a melting point above 20° C., preferably above 25° C., particularly preferably between 25 and 60° C. An in particular between 26.6 and 43.3° C.

Suitable nonionic surfactants which have melting or softening points in the given temperature range are, for example, weakly foaming nonionic surfactants which may be solid or of high viscosity at room temperature. If use is made of nonionic surfactants which have a high viscosity at room temperature, then it is preferred for them to have a viscosity above 20 Pas, preferably above 35 Pas and in particular above 40 Pas. Nonionic surfactants which have a wax-like consistency at room temperature are also preferred.

Preferably, nonionic surfactants solid at room temperature to be used originate from the group of alkoxylated nonionic surfactants, in particular the ethoxylated primary alcohols and mixtures of these surfactants with surfactants with a structurally complicated construction, such as polyoxypropylene/polyoxyethylene/polyoxypropylene (PO/EO/PO) surfactants. Such (PO/EO/PO) nonionic surfactants are characterized, moreover, by good foam control.

In a preferred embodiment of the present invention, the nonionic surfactant with melting point above room temperature is an ethoxylated nonionic surfactant which is obtained from the reaction of a monohydroxyalkanol or alkylphenol having 6 to 20 carbon atoms with preferably at least 12 mol, particularly preferably at least 15 mol, in particular at least 20 mol, of ethylene oxide per mole of alcohol or alkyl phenol.

A particularly preferred nonionic surfactant solid at room temperature to be used is obtained from a straight-chain fatty alcohol having 16 to 20 carbon atoms (C₁₆₋₂₀-alcohol), preferably a C₁₈-alcohol and at least 12 mol, preferably at least 15 mol and in particular at least 20 mol, of ethylene oxide. Of these, the so-called “narrow range ethoxylates” (see above) are particularly preferred.

Accordingly, particularly preferred agents according to the invention comprise ethoxylated nonionic surfactant(s) which has/have been obtained from C₆₋₂₀-monohydroxyalkanols or C₆₋₂₀-alkylphenols or C₆₋₂₀-fatty alcohols and more than 12 mol, preferably more than 15 mol and in particular more than 20 mol of ethylene oxide per mole of alcohol.

The nonionic surfactant preferably additionally has propylene oxide units in the molecule. Preferably, such PO units constitute up to 25% by weight, particularly preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably here constitutes more than 30% by weight, particularly preferably more than 50% by weight and in particular more than 70% by weight, of the total molar mass of such nonionic surfactants. Preferred washing or cleaning agent compositions are characterized in that they comprise ethoxylated and propoxylated nonionic surfactants in which the propylene oxide units in the molecule constitute up to 25% by weight, preferably up to 20% by weight and in particular up to 15% by weight, of the total molar mass of the nonionic surfactant.

Further nonionic surfactants with melting points above room temperature to be used particularly preferably comprise 40 to 70% of a polyoxypropylene/polyoxy-ethylene/polyoxypropylene block polymer blend which 75% by weight of an inverse block copolymer of polyoxyethylene and polyoxypropylene with 17 mol of ethylene oxide and 44 mol of propylene oxide and 25% by weight of a block copolymer of polyoxyethylene and polyoxypropylene initiated with trimethylolpropane and comprising 24 mol of ethylene oxide and 99 mol of propylene oxide per mole of trimethylolpropane.

Nonionic surfactants which can be used with particular preference are obtainable, for example, under the name Poly Tergent® SLF-18 from Olin Chemicals.

A further preferred washing or cleaning agent composition according to the invention comprises nonionic surfactants of the formula

R¹O[CH₂CH(CH₃)O]ₓ[CH₂CH₂O]_{y}[CH₂CH(OH)R²],

in which R¹ is a linear or branched aliphatic hydrocarbon radical having 4 to 18 carbon atoms or mixtures thereof, R² is a linear or branched hydrocarbon radical having 2 to 26 carbon atoms or mixtures thereof, and x is values between 0.5 and 1.5 and y is a value of at least 15.

Further nonionic surfactants to be used with preference are the terminally capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is values between 1 and 30, k and j are values between 1 and 12, preferably between I and 5. If the value x is >2, each R³ in the above formula may be different. R¹ and R² are preferably linear or branched, saturated or unsaturated, aliphatic or aromatic hydrocarbon radicals having 6 to 22 carbon atoms, particular preference being given to radicals having 8 to 18 carbon atoms. For the radical R³, H, —CH₃ or —CH₂CH₃ are particularly preferred. Particularly preferred values for x are in the range from 1 to 20, in particular from 6 to 15.

As described above, each R³ in the above formula may be different if x is >2. As a result of this, the alkylene oxide unit in the square brackets may be varied. If x is, for example, 3, the radical R³ may be chosen in order to form ethylene oxide (R³═H) or propylene oxide (R³═CH₃) units, which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x is chosen here by way of example and it is entirely possible for it to be larger, the scope of variation increasing with increasing values of x and embracing, for example, a large number of (EO) groups, combined with a small number of (PO) groups, or vice versa.

Particularly preferred terminally capped poly(oxyalkylated) alcohols of the above formula have values of k=1 and j=1, so that the above formula is simplified to

R¹O[CH₂CH(R³)O]ₓCH₂CH(OH)CH₂OR².

In the last-mentioned formula, R¹, R² and R³ are as described above and x is numbers from 1 to 30, preferably from 1 to 20 and in particular from 6 to 18. Particular preference is given to surfactants in which the radicals R¹ and R² have 9 to 14 carbon atoms, R³ is H and x assumes values of from 6 to 15.

If the last-mentioned statements are summarized, preference is given to washing or cleaning agent compositions according to the invention which comprise terminally capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is values between 1 and 30, k and j are values between 1 and 12, preferably between 1 and 5, particular preference being given to surfactants of the type

R¹O[CH₂CH(R³)O]ₓCH₂CH(OH)CH₂OR²

in which x is numbers from 1 to 30, preferably from 1 to 20 and in particular from 6 to 18.

In conjunction with said surfactants it is also possible—especially in textile detergents—to use anionic, cationic and/or amphoteric surfactants; due to their foaming behavior, they are only of minor importance in machine dishwashing detergents and in most cases are used only in amounts below 10% by weight, in most cases even below 5% by weight, for example from 0.01 to 2.5% by weight, in each case based on the agent. The agents according to the invention can thus also comprise anionic, cationic and/or amphoteric surfactants as surfactant component.

The anionic surfactants used are, for example, those of the sulfonate and sulfate type. Suitable surfactants of the sulfonate type here are preferably C₉₋₁₃-alkyl-benzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. The esters of α-sulfo fatty acids (ester sulfonates), e.g. the α-sulfonated methyl esters of hydrogenated coconut, palm kernel or tallow fatty acids are also likewise suitable.

Further suitable anionic surfactants are sulfated fatty acid glycerol esters. Fatty acid glycerol esters are understood as meaning the mono-, di- and triesters, and mixtures thereof, as are obtained during the preparation by esterification of a monoglycerol with 1 to 3 mol of fatty acid or during the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric half-esters of C₁₂-C₁₈-fatty alcohols, for example of coconut fatty alcohol, tallow fatty alcohol, lauryl, myristyl, cetyl or stearyl alcohol or of C₁₀-C₂₀-oxo alcohols and those half-esters of secondary alcohols of this chain length. Also preferred are alk(en)ylsulfates of said chain length which contain a synthetic straight-chain alkyl radical prepared on a petrochemical basis and which have an analogous degradation behavior to the suitable compounds based on fatty chemical raw materials. From the point of view of washing, preference is given to the C₁₂-C₁₆-alkylsulfates and C₁₂-C₁₅-alkylsulfates, and C₁₄-C₁₅-alkylsulfates. 2,3-Alkylsulfates, which can be obtained as commercial products from the Shell Oil Company under the name DAN® are also suitable anionic surfactants.

The sulfuiric monoesters of the straight-chain or branched C₇₋₂₁-alcohols ethoxylated with 1 to 6 mol of ethylene oxide, such as 2-methyl-branched C₉₋₁₁-alcohols with, on average, 3.5 mol of ethylene oxide (EO) or C₁₂₋₁₈-fatty alcohols with 1 to 4 EO are also suitable. They are used in cleaning agents only in relatively small amounts, for example amounts of from 1 to 5% by weight, due to their high foaming behavior.

Further suitable anionic surfactants are also the salts of alkylsulfosuccinic acid, which are also referred to as sulfosuccinates or as sulfosuccinic esters and represent the monoesters and/or diesters of sulfosuccinic acid with alcohols, preferably fatty alcohols and in particular ethoxylated fatty alcohols. Preferred sulfosuccinates contain C₈₋₁₈-fatty alcohol radicals or mixtures thereof. Particularly preferred sulfosuccinates contain a fatty alcohol radical which is derived from ethoxylated fatty alcohols which, considered on their own, represent nonionic surfactants (for description see below). In this connection, sulfosuccinates whose fatty alcohol radicals are derived from ethoxylated fatty alcohols with a narrowed homolog distribution are again particularly preferred. It is also likewise possible to use alk(en)ylsuccinic acid having preferably 8 to 18 carbon atoms in the alk(en)yl chain or salts thereof.

Suitable further anionic surfactants are, in particular, soaps. Saturated fatty acid soaps, such as the salts of lauric acid, myristic acid, palmitic acid, stearic acid, hydrogenated erucic acid and behenic acid, and soap mixtures derived in particular from natural fatty acids, e.g. coconut, palm kernel or tallow fatty acids are suitable.

The anionic surfactants including the soaps may be present in the form of their sodium, potassium or ammonium salts, and also in the form of soluble salts of organic bases, such as mono-, di- or triethanolamine. Preferably, the anionic surfactants are in the form of their sodium or potassium salts, in particular in the form of the sodium salts.

As cationic active substances, the agents according to the invention may, for example, comprise cationic compounds of the formulae V, VI or VII:

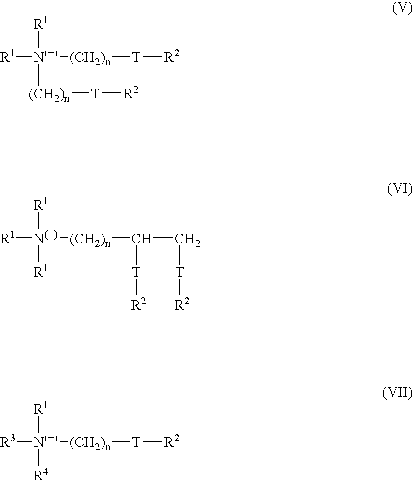

in which each group R¹, independently of the others, is chosen from C₁₋₆-alkyl, -alkenyl or -hydroxyalkyl groups; each group R², independently of the others, is chosen from C₈₋₂₈-alkyl or -alkenyl groups; R³═R¹ or (CH₂)ₙ-T-R², R⁴═R¹ or R² or (CH₂)ₙ-T-R²; T=-CH₂—, —O—CO— or —CO—O— and n is an integer from 0 to 5.

Besides the surfactants and builders, bleaches, bleach activators, enzymes, silver protectants, colorants and fragrances etc. in particular are preferred ingredients of machine dishwashing compositions. In addition, further ingredients may be present, preference being given to machine dishwashing compositions according to the invention which additionally comprise one or more substances from the group of acidifying agents, chelate complexing agents or of film-inhibiting polymers.

Suitable acidifying agents are both inorganic acids and also organic acids, provided they are compatible with the other ingredients. For reasons of consumer protection and of handling safety, the solid mono-, oligo- and polycarboxylic acids in particular can be used. From this group in turn, preference it given to citric acid, tartaric acid, succinic acid, malonic acid, adipic acid, maleic acid, fumaric acid, oxalic acid, and polyacrylic acid. The anhydrides of these acids can also be used as acidifying agents, with maleic anhydride and succinic anhydride in particular being commercially available. Organic sulfonic acids, such as amidosulfonic acid, can likewise be used. A substance which is commercially available and can likewise preferably be used as acidifying agent for the purposes of the present invention is Sokalan® DCS (trade mark of BASF), a mixture of succinic acid (max. 31% by weight), glutaric acid (max. 50% by weight) and adipic acid (max. 33% by weight).

A further possible group of ingredients is the chelate complexing agents. Chelate complexing agents are substances which form cyclic compounds with metal ions where an individual ligand occupies more than one coordination site on a central atom, i.e. is at least “bidentate”. Thus, in this case, compounds which are normally extended are closed to give rings by means of complexation via an ion. The number of bound ligands depends on the coordination number of the central ion.

Chelate complexing agents which are customary and preferred for the purposes of the present invention are, for example, polyoxycarboxylic acids, polyamines, ethylenediaminetetraacetic acid (EDTA) and nitrilotriacetic acid (NTA). Complexing polymers, i.e. polymers which carry, either in the main chain itself or in a side position relative to this, functional groups which can act as ligands and usually react with suitable metal atoms to form chelate complexes can also be used according to the invention. The polymer-bound ligands of the resulting metal complexes may originate here from only one macromolecule, or else belong to different polymer chains. The latter leads to crosslinking of the material, if the complexing polymers were not already crosslinked beforehand via covalent bonds.

Complexing groups (ligands) of customary complexing polymers are iminodiacetic acid, hydroxyquinoline, thiourea, guanidine, dithiocarbamate, hydroxamic acid, amide oxime, aminophosphoric acid, (cyclic) polyamino, mercapto, 1,3-dicarbonyl and crown ether radicals, some with very specific activities toward ions of different metals. Basis polymers of many, including commercially significant, complexing polymers are polystyrene, polyacrylate, polyacrylonitriles, polyvinyl alcohols, polyvinylpyridines and polyethyleneimines. Natural polymers such as cellulose, starch or chitin are also complexing polymers. Moreover, these can be provided with further ligand functionalities as a result of polymer-analogous conversions.

For the purposes of the present invention, particular preference is given to machine dishwashing detergents which comprise one or more chelate complexing agents from the groups of

(i) polycarboxylic acids in which the sum of the carboxyl and optionally hydroxyl groups is at least 5,

(ii) nitrogen-containing mono- or polycarboxylic acids,

(iii) geminal diphosphonic acids,

(iv) aminophosphonic acids,

(v) phosphonopolycarboxylic acids,

(vi) cyclodextrins

in amounts above 0.1% by weight, preferably above 0.5% by weight, particularly preferably above 1% by weight and in particular above 2.5% by weight, in each case based on the weight of the dishwashing detergent.

For the purposes of the present invention it is possible to use all complexing agents from the prior art. These may belong to different chemical groups. Preference is given to using, individually or in a mixture with one another:

a) polycarboxylic acid in which the sum of the carboxyl and optionally hydroxyl groups is at least 5, such as gluconic acid,

b) nitrogen-containing mono- or polycarboxylic acids, such as ethylenediamine tetraacetic acid (EDTA), N-hydroxyethylethylenediaminetriacetic acid, diethylene-triaminepentaacetic acid, hydroxyethylaminodiacetic acid, nitridodiacetic acid-3-propionic acid, isoserinediacetic acid, N,N-di(β-hydroxyethyl)glycine, N-(1,2-dicarboxy-2-hydroxyethyl)glycine, N-(1,2-dicarboxy-2-hydroxyethyl)aspartic acid or nitrilotriacetic acid (NTA),

c) geminal diphosphonic acids, such as 1-hydroxyethane-1,1-diphosphonic acid (HEDP), higher homologs thereof having up to 8 carbon atoms, and also derivatives thereof containing hydroxyl or amino groups, and 1-aminoethane-1,1-diphosphonic acid, higher homologs thereof having up to 8 carbon atoms, and also derivatives thereof containing hydroxyl or amino groups,

d) aminophosphonic acids, such as ethylenediaminetetra(methylenephosphonic acid), diethylenetriaminepenta(methylenephosphonic acid) or nitrilotri(methylenephosphonic acid),

e) phosphonopolycarboxylic acids, such as 2-phosphonobutane-1,2,4-tricarboxylic acid, and

f) cyclodextrins.

For the purposes of this patent application, polycarboxylic acids a) are understood as meaning carboxylic acids—including monocarboxylic acids—in which the sum of carboxyl and the hydroxyl groups present in the molecule is at least 5. Complexing agents from the group of nitrogen-containing polycarboxylic acids, in particular EDTA, are preferred. At the alkaline pH values of the treatment solutions required according to the invention, these complexing agents are present at least partially in the form of anions. It is unimportant whether they are introduced in the form of the acids or in the form of salts. In the case of the use in the form of salts, preference is given to alkali metal, ammonium or alkylammonium salts, in particular sodium salts.

Film-inhibiting polymers may likewise be present in the agents according to the invention. These substances, which may have chemically different structures, originate, for example, from the groups of low molecular weight polyacrylates with molar masses between 1000 and 20 000 daltons, preference being given to polymers with molar masses below 15 000 daltons.

Film-inhibiting polymers may also have cobuilder properties. Organic cobuilders which may be used in the machine dishwashing detergents according to the invention are, in particular, polycarboxylates/polycarboxylic acids, polymeric polycarboxylates, aspartic acid, polyacetals, dextrins, further organic cobuilders (see below), and phosphonates. These classes of substance are described below.

Organic builder substances which can be used are, for example, the polycarboxylic acids which can be used in the form of their sodium salts, polycarboxylic acids being understood as meaning those carboxylic acids which carry more than one acid function. For example, these are citric acid, adipic acid, succinic acid, glutaric acid, malic acid, tartaric acid, maleic acid, fumaric acid, sugar acids, aminocarboxylic acids, nitrilotriacetic acid (NTA), if such a use is not objectionable for ecological reasons, and mixtures thereof. Preferred salts are the salts of the polycarboxylic acids, such as citric acid, adipic acid, succinic acid, glutaric acid, tartaric acid, sugar acids and mixtures thereof.

The acids per se may also be used. Besides their builder effect, the acids typically also have the property of an acidification component and thus also serve to establish a lower and milder pH of washing or cleaning agents. In particular, mention may be made here of citric acid, succinic acid, glutaric acid, adipic acid, gluconic acid and any mixtures thereof.

Also suitable as builders or film inhibitor are polymeric polycarboxylates, these are, for example, the alkali metal salts of polyacrylic acid or of polymethacrylic acid, for example those with a relative molecular mass of from 500 to 70 000 g/mol.

For the purposes of this specification, the molar masses given for polymeric polycarboxylates are weight-average molar masses M_{w} of the particular acid form, which has in principle been determined by gel permeation chromatography (GPC), using a UV detector. The measurement is made against an external polyacrylic acid standard which, due to its structural similarity to the polymers investigated, produces realistic molecular weight values. This data differs significantly from the molecular weight data for which polystyrenesulfonic acids are used as standard. The molar masses measured against polystyrenesulfonic acids are usually significantly higher than the molar masses given in this specification.

Suitable polymers are, in particular, polyacrylates which preferably have a molecular mass of from 2000 to 20 000 g/mol. Due to their superior solubility, the short-chain polyacrylates, which have molar masses of from 2000 to 10 000 g/mol, and particularly preferably from 3000 to 5000 g/mol, can in turn be preferred from this group.

Also suitable are copolymeric polycarboxylates, in particular those of acrylic acid with methacrylic acid and of acrylic or methacrylic acid with maleic acid. Copolymers of acrylic acid with maleic acid which contain 50 to 90% by weight of acrylic acid and 50 to 10% by weight of maleic acid have proven to be particularly suitable. Their relative molecular mass, based on free acids, is generally 2000 to 70 000 g/mol, preferably 20 000 to 50 000 g/mol and in particular 30 000 to 40 000 g/mol.

The (co)polymeric polycarboxylates can either be used in the form of powders or in the form of aqueous solutions. The content of (co)polymeric polycarboxylates is preferably 0.5 to 20% by weight, in particular 3 to 10% by weight.

Particular preference is also given to biodegradable polymers of more than two different monomer units, for example those which contain, as monomers, salts of acrylic acid and of maleic acid, and also vinyl alcohol or vinyl alcohol derivatives, or those which contain, as monomers, salts of acrylic acid and of 2-alkylallylsulfonic acid and sugar derivatives. Further preferred copolymers are those which preferably have acrolein and acrylic acid/acrylic acid salts or acrolein and vinyl acetate as monomers.

Likewise to be mentioned as further preferred builder substances are polymeric aminodicarboxylic acids, salts thereof or precursor substances thereof. Particular preference is given to polyaspartic acids or salts and derivatives thereof which also have a bleach-stabilizing effect besides cobuilder properties.

Further suitable builder substances are polyacetals which can be obtained by reacting dialdehydes with polyolcarboxylic acids which have 5 to 7 carbon atoms and at least 3 hydroxyl groups. Preferred polyacetals are obtained from dialdehydes, such as glyoxal, glutaraldehyde, terephthalaldehyde, and mixtures thereof and from polyolcarboxylic acids, such as gluconic acid and/or glucoheptonic acid.

Further suitable organic builder substances are dextrins, for example oligomers or polymers of carbohydrates, which can be obtained by partial hydrolysis of starches. The hydrolysis can be carried out in accordance with customary, for example acid-catalyzed or enzyme-catalyzed, processes. They are preferably hydrolysis products with average molar masses in the range from 400 to 500 000 g/mol. Preference is given here to a polysaccharide with a dextrose equivalent (DE) in the range from 0.5 to 40, in particular from 2 to 30, where DE is a customary measure of the reducing effect of a polysaccharide compared with dextrose, which has a DE of 100. Maltodextrins with a DE between 3 and 20 and dry glucose syrup with a DE between 20 and 37 and also so-called yellow dextrins and white dextrins with relatively high molar masses in the range from 2000 to 30 000 g/mol can also be used.

The oxidized derivatives of such dextrins are their reaction products with oxidizing agents which are able to oxidize at least one alcohol function of the saccharide ring to the carboxylic acid function. A product oxidized on C₆ of the saccharide ring may be particularly advantageous.

Oxidisuccinates and other derivatives of disuccinates, preferably ethylenediamine disuccinate are also further suitable cobuilders. Ethylenediamine N,N′-disuccinate (EDDS) is preferably used here in the form of its sodium or magnesium salts. Preference is also given in this connection to glycerol disuccinates and glycerol trisuccinates. Suitable use amounts are 3 to 15% by weight in zeolite-containing and/or silicate-containing formulations.

Further organic cobuilders which can be used are, for example, acetylated hydroxycarboxylic acids and salts thereof, which may optionally also be in lactone form and which, contain at least 4 carbon atoms and at least one hydroxyl group, and at most two acid groups.

A further class of substance with cobuilder properties is the phosphonates. These are, in particular, hydroxyalkane- or aminoalkanephosphonates. Among the hydroxyalkanephosphonates, 1-hydroxyethane-1,1-diphosphonate (HEDP) is of particular importance as a cobuilder. It is preferably used in the form of the sodium salt, the disodium salt giving a neutral reaction and the tetrasodium salt giving an alkaline reaction (pH 9). Suitable aminoalkanephosphonates are preferably ethylenediamine tetramethylenephosphonate (EDTMP), diethylenetriamine pentamethylenephosphonate (DTPMP), and higher homologs thereof. They are preferably used in the form of the neutrally reacting sodium salts, e.g. in the form of the hexasodium salt of EDTMP and/or in the form of the hepta- and octa-sodium salt of DTPMP. As builder, preference is given to using HEDP from the class of phosphonates. The aminoalkanephosphonates additionally have marked capacity to bind heavy metals. Accordingly, it may be preferred, particularly when the compositions also comprise bleaches, to use aminoalkanephosphonates, in particular DTPMP, or to use mixtures of said phosphonates.

The dosed agents according to the invention can, moreover, contain copolymers of unsaturated carboxylic acids, monomers containing sulfonic acid groups and optionally further ionic or nonionogenic monomers. These copolymers mean that the areas of dishes treated with such agents become significantly cleaner upon subsequent cleaning operations than parts of dishes which were washed with conventional agents. An additional positive effect which arises is a shortening of the drying time of the parts of dishes treated with the cleaning agent, i.e. the consumer can then take the dishes out of the machine earlier and reuse them after the cleaning program has finished.

The invention is characterized by improved “cleanability” of the treated substrates during later cleaning operations and by a considerable shortening of the drying time compared with comparable agents without the use of polymers containing sulfonic acid groups. For the purposes of the teaching according to the invention, drying time is generally understood as having the literal meaning of the word, i.e. the time which passes until a surface of dishes treated in a dishwasher has dried, but in particular the time which passes until 90% of a surface treated with a detergent or a rinseaid in concentrated or dilute form has dried.

It is also advantageous that said polymers act as salt replacement in suitable amounts. When using such agents, the consumer does not have to top up the regenerating salt supply of his dishwasher but nevertheless gets streak-free, mark-free and film-free dishes.

Within the scope of the present invention, preference is given to unsaturated carboxylic acids of the formula VIII as monomer,

R¹(R²)C═C(R³)COOH (VII),

in which R¹ to R³, independently of the others, is —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted by —NH₂, —OH or —COOH, as defined above or is —COOH or —COOR⁴, where R⁴ is a saturated or unsaturated straight-chain or branched hydrocarbon radical having 1 to 12 carbon atoms.

Among the unsaturated carboxylic acids which can be described by the formula I, preference is given in particular to acrylic acid (R¹═R²═R³═H), methacrylic acid (R¹═R²═H; R³═CH₃) and/or maleic acid (R¹═COOH; R²═R³═H).

The monomers containing sulfonic acid groups are preferably those of the formula IX,

R⁵(R⁶)C═C(R⁷)—X—SO₃H (IX),

in which R⁵ to R⁷, independently of the others, is —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted by —NH_{2,} —OH or —COOH, as defined above, or is —COOH or —COOR⁴, where R⁴ is a saturated or unsaturated, straight-chain or branched hydrocarbon radical having 1 to 12 carbon atoms, and X is an optionally present spacer group which is chosen from —(CH₂)ₙ— where n=0 to 4, —COO—(CH₂)ₖ— where k=1 to 6, —C(O)—NH—C(CH₃)₂— and —C(O)—NH—CH(CH₂CH₃)—.

Among these monomers, preference is given to those of the formulae IXa, IXb and/or IXc,

H₂C═CH—X—SO₃H (IXa),

H₂C═C(CH₃)—X—SO₃H (IXb),

HO₃S—X—(R⁶)C═C(R⁷)—X—SO₃H (IXc),

in which R⁶ and R⁷, independently of one another, are chosen from —H, —CH₃, —CH₂CH₃, —CH₂CH₂CH₃, —CH(CH₃)₂ and X is an optionally present spacer group which is chosen from —(CH₂)ₙ— where n=0 to 4, —COO—(CH₂)ₖ— where k=1 to 6, —C(O)—NH—C(CH₃)₂— and —C(O)—NH—CH(CH₂CH₃)—.

Particularly preferred monomers containing sulfonic acid groups here are 1-acrylamido-1-propanesulfonic acid (X═—C(O)NH—CH(CH₂CH₃) in formula IXa), 2-acrylamido-2-propanesulfonic acid (X═—C(O)NH—C(CH₃)₂ in formula IXa), 2-acrylamido-2-methyl-1-propanesulfonic acid (X═—C(O)NH—CH(CH₃)CH₂— in formula IXa), 2-methacrylamido-2-methyl-1-propanesulfonic acid (X═—C(O)NH—CH(CH₃)CH₂— in formula IXb), 3-methacrylamido-2-hydroxypropanesulfonic acid (X═—C(O)NH—CH₂CH(OH)CH₂ in formula IXb), allylsulfonic acid (X═CH₂ in formula IXa), methallylsulfonic acid (X═CH₂ in formula IXb), allyloxybenzenesulfonic acid (X═—CH₂—O—C₆H₄— in formula IXa), methallyloxybenzenesulfonic acid (X═—CH₂—O—C₆H₄— in formula IXb), 2-hydroxy-3-(2-propenyloxy)propanesulfonic acid, 2-methyl-2-propene-1-sulfonic acid (X═CH₂ in formula IXb), styrenesulfonic acid (X═C₆H₄ in formula IXa), vinylsulfonic acid (X not present in formula IXa), 3-sulfopropyl acrylate (X═—C(O)NH—CH₂CH₂CH₂— in formula IXa), 3-sulfopropyl methacrylate (X═—C(O)NH—CH₂CH₂CH₂— in formula IXb), sulfomethacrylamide (X═—C(O)NH— in formula IXb), sulfomethylmethacrylamide (X═—C(O)NH—CH₂— in formula IXb) and water-soluble salts of said acids.

Suitable further ionic or nonionogenic monomers are, in particular, ethylenically unsaturated compounds. The content of monomers of group iii) in the polymers used according to the invention is preferably less than 20% by weight, based on the polymer. Polymers to be used particularly preferably consist merely of monomers of groups i) and ii).

In summary, copolymers of

i) unsaturated carboxylic acids of the formula VIII

R¹(R²)C═C(R³)COOH (VIII),

in which R¹ to R³, independently of the others, is —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted by —NH_{2,} —OH or —COOH, as defined above, or is —COOH or —COOR⁴, where R⁴ is a saturated or unsaturated, straight-chain or branched hydrocarbon radical having 1 to 12 carbon atoms,

ii) monomers of the formula IX containing sulfonic acid groups

R⁵(R⁶)C═C(R⁷)—X—SO₃H (IX),

in which R⁵ to R⁷, independently of the others, is —H —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted by —NH_{2,} —OH or —COOH, as defined above, or is —COOH or —COOR⁴, where R⁴ is a saturated or unsaturated, straight-chain or branched hydrocarbon radical having 1 to 12 carbon atoms, and X is an optionally present spacer group which is chosen from —(CH₂), where n=0 to 4, —COO—(CH₂)ₖ— where k=1 to 6, —C(O)—NH—C(CH₃)₂— —C(O)—NH—CH(CH₂CH₃)—

iii) optionally further ionic or nonionogenic monomers are particularly preferred.

Particularly preferred copolymers consist of

i) one or more unsaturated carboxylic acids from the group consisting of acrylic acid, methacrylic acid and/or maleic acid

ii) one or more monomers containing sulfonic acid groups of the formulae IIa, IIb and/or IXc:

H₂C═CH—X—SO₃H (IXa),

H₂C═C(CH₃)—X—SO₃H (IXb),

HO₃S—X—(R⁶)C═C(R⁷)—X—SO₃H (IXc),

in which R⁶ and R⁷, independently of one another, are chosen from —H, —CH₃, —CH₂CH₃, —CH₂CH₂CH₃, —CH(CH₃)₂ and X is an optionally present spacer group which is chosen from —(CH₂)ₙ— where n=0 to 4, —COO—(CH₂)ₖ— where k=1 to 6, —C(O)—NH—C(CH₃)₂— and —C(O)—NH—CH(CH₂CH₃)—

iii) optionally further ionic or nonionogenic monomers.

The copolymers used according to the invention in the agents may comprise the monomers from groups i) and ii) and optionally iii) in varying amounts, it being possible to combine all of the representatives from group i) with all of the representatives from group ii) and all of the representatives from group iii). Particularly preferred polymers have certain structural units which are described below.

Thus, for example, preference is given to agents according to the invention which are characterized in that they comprise one or more copolymers which contain structural units of the formula X

—[CH₂—CHCOOH]ₘ—[CH₂—CHC(O)—Y—SO₃H]ₚ— (X),

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—.

These polymers are prepared by copolymerization of acrylic acid with an acrylic acid derivative containing sulfonic acid groups. Copolymerizing the acrylic acid derivative containing sulfonic acid groups with methacrylic acid leads to another polymer, the use of which in the agents according to the invention is likewise preferred and characterized in that the agents comprise one or more copolymers which contain structural units of the formula XI

—[CH₂—C(CH₃)COOH]ₘ—[CH₂—CHC(O)—Y—SO₃H]ₚ— (XI)

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ— where n=0 to 4, is —O—(C₆H₄)—, is —NH—C(CH₃)₂— or —N—H—CH(CH₂CH₃)—.

Acrylic acid and/or methacrylic acid can also be copolymerized entirely analogously with methacrylic acid derivatives containing sulfonic acid groups, as a result of which the structural units within the molecule are changed. For example, agents according to the invention which comprise one or more copolymers which contain structural units of the formula XII

—[CH₂—CHCOOH]ₘ—[CH₂—C(CH₃)C(O)—Y—SO₃H]ₚ— (XII),

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—, are just as much a preferred embodiment of the present invention as agents which are characterized in that they comprise one or more copolymers which contain structural units of the formula XIII

—[CH₂—C(CH₃)COOH]ₘ—[CH₂—C(CH₃)C(O)—Y—SO₃H]ₚ— (XIII),

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—.

Instead of acrylic acid and/or methacrylic acid, or in addition to them, it is also possible to use maleic acid as particularly monomer from group i). This leads to agents preferred according to the invention which are characterized in that they comprise one or more copolymers which contain structural units of the formula XIV

—[HOOCCH—CHCOOH]ₘ—[CH₂—CHC(O)—Y—SO₃H]ₚ— (XIV),

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—, and to agents which are characterized in that they comprise one or more copolymers which contain structural units of the formula XV

—[HOOCCH—CHCOOH]ₘ—[CH₂—C(CH₃)C(O)O—Y—SO₃H]ₚ— (XV),

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ— where n=0 to 4, is —O—(C₆H₄)—, is —NH—C(CH₃)₂— or —NH—CH(CH₂CH₃)—.

In summary, preference is given to machine dishwashing detergents according to the invention which comprise, as ingredient b), one or more copolymers which contain structural units of the formulae III and/or IV and/or V and/or VI and/or VII and/or VIII

—[CH₂—CHCOOH]ₘ—[CH₂—CHC(O)—Y—SO₃H]ₚ— (X),

—[CH₂—C(CH₃)COOH]ₘ—[CH₂—CHC(O)—Y—SO₃H]ₚ— (XI),

—[CH₂—CHCOOH]ₘ—[CH₂—C(CH₃)C(O)—Y—SO₃H]ₚ— (XII),

—[CH₂—C(CH₃)COOH]ₘ—[CH₂—C(CH₃)C(O)—Y—SO₃H]ₚ— (XIII),

—[HOOCCH—CHCOOH]ₘ—[CH₂—CHC(O)—Y—SO₃H]ₚ— (XIV),

—[HOOCCH—CHCOOH]ₘ—[CH₂—C(CH₃)C(O)O—Y—SO₃H]ₚ— (XV),

in which m and p is in each case a whole natural number between 1 and 2000, and Y is a spacer group chosen from substituted or unsubstituted aliphatic, aromatic or araliphatic hydrocarbon radicals having 1 to 24 carbon atoms, preference being given to spacer groups in which Y is —O—(CH₂)ₙ—where n=0 to 4, is —O—(C₆H₄)—, is —NH—C(CH₃)₂— or —NH—CH(CH₂CH₃)—.

In the polymers some or all of the sulfonic acid groups maybe in neutralized form, i.e. the acidic hydrogen atom of the sulfonic acid group may in some or all of the sulfonic acid groups be replaced by metal ions, preferably alkali metal ions and in particular by sodium ions. Corresponding agents which are characterized in that the sulfonic acid groups within the copolymer are present in partially or completely neutralized form are preferred in accordance with the invention.

The monomer distribution of the copolymers used in the agents according to the invention is, in the case of copolymers which contain only monomers from groups i) and ii), preferably in each case 5 to 95% by weight of i) or ii), particularly preferably 50 to 90% by weight of monomer from group i) and 10 to 50% by weight of monomer from group ii), in each case based on the polymer.

In the case of terpolymers, particular preference is given to those which contain 20 to 85% by weight of monomer from group i), 10 to 60% by weight of monomer from group ii), and 5 to 30% by weight of monomer from group iii).

The molar mass of the polymers used in the agents according to the invention can be varied in order to adapt the properties of the polymers to the desired intended use. Preferred machine dishwashing detergents are characterized in that the copolymers have molar masses of from 2000 to 200 000 gmol⁻¹, preferably from 4000 to 25 000 gmol^{31 1} and in particular from 5000 to 15 000 gmol⁻¹.

The content of one or more copolymers in the agents according to the invention can vary depending on the intended use and desired product performance, preferred machine dishwashing detergents according to the invention being characterized in that they comprise the copolymer(s) in amounts of from 0.25 to 50% by weight, preferably from 0.5 to 35% by weight, particularly preferably from 0.75 to 20% by weight and in particular from 1 to 15% by weight.

For regulating the viscosity, the agents according to the invention can comprise further ingredients with whose use it is possible, for example, to control in a targeted manner the settling behavior or the pourability and/or flowability. In nonaqueous systems, combinations of structure-imparting agents and thickeners in particular have proven useful here.

Machine dishwashing detergents preferred for the purposes of the present invention further comprise

a) 0.1 to 1.0% by weight of one or more structure-imparting agents from the group of bentonites and/or at least partially etherified sorbitols and

b) 5.0 to 30% by weight of one or more thickeners from the group of carbonates, sulfates and amorphous or crystalline disilicates.

The structure-imparting agent a) originates from the group of bentonites and/or at least partially etherified sorbitols. These substances are used in order to ensure the physical stability of the agents and to adjust the viscosity. Although conventional thickening agents such as polyacrylates or polyurethanes do not work in nonaqueous media, it is possible to regulate the viscosity using said substances in the nonaqueous system.

Bentonites are contaminated clays which are produced as a result of the weathering of volcanic tuffs. Due to their high content of montmorillonite, bentonites have valuable properties such as swellability, ion-exchange capacity and thixotropy. Here, it is possible to modify the properties of the bentonites according to the intended use. Bentonites are often in the form of a clay constituent in tropical soils and are extracted in the form of sodium bentonite, e.g. in Wyoming/USA. Sodium bentonite has the most favorable application properties (swellability), meaning that its use is preferred within the scope of the present invention. Naturally occurring calcium bentonites originate, for example, from Mississippi/USA or Texas/USA or from Landshut/Germany. The naturally recovered Ca bentonites are converted artificially into the more swellable Na bentonites by replacing Ca with Na.

The main constituents of the bentonites form so-called montmorillonites, which can also be used in pure form for the purposes of the present invention.

Montmorillonites are clay minerals which belong to the phyllosilicates and here to the dioctahedral smectites, and which crystallize in a monoclinically-pseudohexagonally manner. Montmorillonites form predominantly white, grey-white to yellowish, readily friable masses which appear completely amorphous and which swell in water, but do not become plastic and which can be described by the general formulae

Al₂[(OH)₂/Si₄O₁₀].nH₂O and

Al₂O₃.4SiO₂.H₂O.nH₂O and

Al₂[(OH)₂/Si₄O₁₀] (dried at 150° C.].

Preferred machine dishwashing detergents are characterized in that montmorillonites are used as structure-imparting agents. Montmorillonites have a three-layer structure which consists of two tetrahedron layers which are crosslinked electrostatically via the cations of an octahedron intermediate layer. The layers are not joined in rigid fashion, but can swell as a result of reversible intercalation of water (2-7-fold amount) and other substances, such as, for example, alcohols, glycols, pyridine, α-picoline, ammonium compounds, hydroxy-aluminosilicate ions etc. The abovementioned formulae represent only approximate formulae since montmorillonites have a large ion-exchange capacity. For example, Al can be replaced by Mg, Fe²⁺, Fe³⁺, Zn, Cr, Cu and other ions. Such a substitution results in the layers being negatively charged, which is balanced by other cations, in particular Na⁺ and Ca²⁺.

In combination with the bentonites or as a replacement for them when their use is not desired, it is possible to use at least partially etherified sorbitols as structure-imparting agents.

Sorbitol is a 6-hydric alcohol belonging to the hexitols (sugar alcohol), which eliminates one or two mol of water relatively easily intramolecularly and forms cyclic ethers, for example sorbitan and sorbide). The elimination of water is also possible intermolecularly, in which case noncyclic ethers form from sorbitol and the alcohols in question. Also possible here is the formation of mono-ethers and bis-ethers, it also being possible for higher degrees of etherification to arise, such as 3 and 4. At least partially etherified sorbitols to be used with preference within the scope of the present invention are dietherified sorbitols, of which dibenzylidenesorbitol is particularly preferred. Preference is given here to machine dishwashing agents which comprise dietherified sorbitols, in particular dibenzylidenesorbitol, as structure-imparting agent.

The agents according to the invention can comprise the structure-imparting agents in amounts of from 0.1 to 1.0% by weight, based on the total agent and on the active substance of the structure-imparting agent. Preferred agents comprise the structure-imparting agent in amounts of from 0.2 to 0.9% by weight, preferably in amounts of from 0.25 to 0.75% by weight and in particular in amounts of from 0.3 to 0.5% by weight, in each case based on the total agent.

As thickeners, the preferred agents according to the invention can comprise inorganic salts from the group of carbonates, sulfates and amorphous or crystalline disilicates. In principle, it is possible here to use said salts of all metals, preference being given to the alkali metal salts. For the purposes of the present invention, particularly preferred thickeners are alkali metal carbonate(s), alkali metal sulfate(s) and/or amorphous and/or crystalline alkali metal disilicate(s), preferably sodium carbonate, sodium sulfate and/or amorphous or crystalline sodium disilicate.

The preferred agents according to the invention comprise the thickeners in amounts of from 5 to 30% by weight, based on the total agent. Particularly preferred agents comprise the thickener or the thickeners in amounts of from 7.5 to 28% by weight, preferably in amounts of from 10 to 26% by weight and in particular in amounts of from 12.5 to 25% by weight, in each case based on the total agent.

With regard to an increased settling stability, it is preferred that the solids present in the agents according to the invention are used in the most finely divided form possible. This is advantageous particularly in the case of the inorganic thickeners and in the case of the bleaches. Preference is given here to machine dishwashing detergents according to the invention in which the average particle size of the bleaches and thickeners, and of the optional builders to be used is less than 75 μm, preferably less than 50 μm and in particular less than 25 μm.

In order to establish a high viscosity which may be desired, the liquid machine dishwashing detergents according to the invention can also comprise other viscosity regulators and/or thickeners. All known thickeners can be used for this purpose, i.e. those based on natural or synthetic polymers.

Polymers originating in nature which are used as thickeners are, for example, agar agar, carrageen, tragacanth, gum arabic, alginates, pectins, polyoses, guar flour, carob seed flour, starch, dextrins, gelatin and caseine. Modified natural substances originate primarily from the group of modified starches and celluloses, carboxymethylcellulose and other cellulose ethers, hydroxyethylcellulose and hydroxypropylcellulose, and seed flour ethers being mentioned here by way of example.

Machine dishwashing detergents preferred within the scope of the present invention comprise, as thickeners, hydroxyethylcellulose and/or hydroxypropylcellulose, preferably in amounts of from 0.01 to 4.0% by weight, particularly preferably in amounts of from 0.01 to 3.0% by weight and in particular in amounts of from 0.01 to 2.0% by weight, in each based on the total agent.

A large group of thickeners which are used widely in very diverse fields of application are the completely synthetic polymers, such as polyacrylic and polymethacrylic compounds, vinyl polymers, polycarboxylic acids, polyethers, polyimines, polyamides and polyurethanes.

Thickeners from said classes of substance are widely available commercially and are available, for example, under the trade names Acusol®-820 (methacrylic acid(stearyl alcohol-20-EO) ester-acrylic acid copolymer, 30% strength in water, Rohm & Haas), Dapral®-GT-282-S (alkyl polyglycol ether, Akzo), Deuterol® Polymer-11 (dicarboxylic acid copolymer, Schöner GmbH), Deuteron®-XG (anionic heteropoly-saccharide based on β-D-glucose, D-mannose, D-glucuronic acid, Schöner GmbH), Deuteron®-XN (nonionogenic polysaccharide, Schöner GmbH), Dicrylan®D-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm &-Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A preferred polymeric thickener to be used is xanthan, a microbial anionic heteropolysaccharide which is produced by Xanthomonas campestris and a few other species under aerobic conditions and has a molar mass of from 2 to 15 million daltons. Xanthan is formed from a chain with β-1,4-bonded glucose (cellulose) with side chains. The structure of the subgroups consists of glucose, mannose, glucuronic acid, acetate and pyruvate, where the number of pyruvate units determines the viscosity of the xanthan.

Thickeners which are likewise preferred for use within the scope of the present invention are polyurethanes or modified polyacrylates which, based on the total agent, can be used, for example, in amounts of from 0.1 to 5% by weight.

Polyurethanes (PUR) are prepared by polyaddition of dihydric and polyhydric alcohols and isocyanates and can be described by the general formula XVI

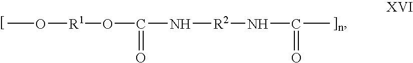

in which R¹ is a low molecular weight or polymeric diol radical, R² is an aliphatic or aromatic group and n is a natural number. R¹ here is preferably a linear or branched C₂₋₁₂-alk(en)yl group, but can also be a radical of a polyhydric alcohol, as a result of which crosslinked polyurethanes are formed which differ from the formula VIII given above in that further —O—CO—NH groups are bonded to the radical R¹.

Industrially important PURs are prepared from polyester- and/or polyetherdiols and for example e.g. from 2,4- or 2,6-toluene diisocyanate (TDI, R²═C₆H₃—CH₃), 4,4′-methylenedi(phenylisocyanate) (MDI, R²═C₆H₄—CH₂—C₆H₄) or hexamethylene diisocyanate [HMDI, R═(CH₂)₆].

Standard commercial thickeners based on polyurethane are available, for example, under the names Acrysol®PM 12 V (mixture of 3-5% modified starch and 14-16% PUR resin in water, Rohm & Haas), Borchigel® L75-N (nonionogenic PUR dispersion, 50% strength in water, Borchers), Coatex® BR-100-P (PUR dispersion, 50% strength in water/butyl glycol, Dimed), Nopco® DSX-1514 (PUR dispersion, 40% strength in water/butyl triglycol, Henkel-Nopco), thickener QR 1001 (20% strength PUR emulsion in water/diglycol ether, Rohm & Haas) and Rilanit® VPW-3116 (PUR dispersion, 43% strength in water, Henkel). For the purposes of the present invention, when using aqueous dispersions it should be ensured that the water content of the agents according to the invention remains within the limits given above. If the use of aqueous dispersions is not possible for these reasons, it is possible to use dispersions in other solvents, or else the solids.

Modified polyacrylates which can be used for the purposes of the present invention are derived, for example, from acrylic acid or methacrylic acid and can be described by the general formula XVII

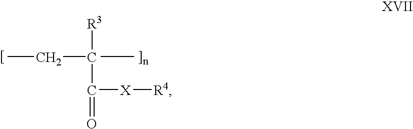

in which R³is H or a branched or unbranched C₁₋₄-alk(en)yl radical, X is N—R⁵ or O, R⁴ is an optionally alkoxylated branched or unbranched, possibly substituted C₈₋₂₂-alk(en)yl radical, R⁵ is H or R⁴ and n is a natural number. Such modified polyacrylates are generally esters or amides of acrylic acid or of an α-substituted acrylic acid. Among these polymers, preference is given to those in which R³ is H or a methyl group. In the case of the polyacrylamides (X═N—R⁵), both mono- (R⁵═H) and also di- (R⁵═R⁴) N-substituted amide structures are possible, where the two hydrocarbon radicals which are bonded to the N atom can be chosen independently of one another from optionally alkoxylated branched or unbranched C₈₋₂₂-alk(en)yl radicals. Among the polyacrylic esters (X═O), preference is given to those in which the alcohol has been obtained from natural or synthetic fats or oils and is additionally alkoxylated, preferably ethoxylated. Preferred degrees of alkoxylation are between 2 and 30, particular preference being given to degrees of alkoxylation between 10 and 15.

Since the polymers which can be used are technical-grade compounds, the designation of the radicals bonded to X is a statistical average value which can vary in the individual case with regard to chain length and/or degree of alkoxylation. The formula IX merely gives formulae for idealized homopolymers. However, for the purposes of the present invention, it is also possible to use copolymers in which the fraction of monomer units which satisfy the formula IX is a least 30% by weight. Thus, it is also possible, for example, to use copolymers of modified polyacrylates and acrylic acid or salts thereof which still have acidic H atoms or basic —COO⁻ groups.

Modified polyacrylates to be used with preference for the purposes of the present invention are polyacrylate-polymethacrylate copolymers which satisfy the formula XVIIa

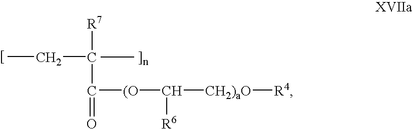

in which R⁴ is a preferably unbranched, saturated or unsaturated C₈₋₂₂-alk(en)yl radical, R⁶ and R⁷, independently of one another, are H or CH₃, the degree of polymerization n is a natural number and the degree of alkoxylation a is a natural number between 2 and 30, preferably between 10 and 20. R⁴ here is preferably a fatty alcohol radical which has been obtained from natural or synthetic sources, the fatty alcohol again preferably being ethoxylated (R⁶═H).

Products of the formula Xa are commercially available, for example under the name Acusol® 820 (Rohm & Haas) in the form of 30% strength by weight dispersions in water. In said commercial product, R⁴ is a stearyl radical, R⁶ is a hydrogen atom, R⁷ is H or CH₃ and the degree of ethoxylation a is 20. That stated above with regard to the water content of the agent also applies to this dispersion.

Dosed washing or cleaning agent compositions preferred for the purposes of the present invention additionally comprise 0.01 to 5% by weight, preferably 0.02 to 4% by weight, particularly preferably 0.05 to 3% by weight and in particular 0.1 to 1.5% by weight, of a thickener, preferably a polymeric thickener, preferred thickeners being hydroxyethylcellulose and/or hydroxypropylcellulose and/or thickeners from the group of polyurethanes or of modified polyacrylates, particularly preferably from thickeners of the formula XVII

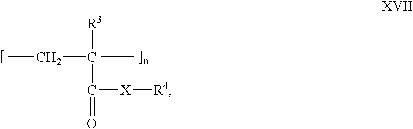

in which R³ is H or a branched or unbranched C₁₋₄-alk(en)yl radical, X is N—R⁵ or O, R⁴ is an optionally alkoxylated branched or unbranched, possibly substituted C₈₋₂₂-alk(en)yl radical, R⁵ is H or R⁴ and n is a natural number.

In addition to the substances from said classes of substance, the agents according to the invention can comprise further customary ingredients of cleaning agents, bleaches, bleach activators, enzymes, silver protectants, colorants and fragrances being of particular importance. These substances are described below.

Among the compounds which serve as bleaches and produce H₂O₂ in water, sodium perborate tetrahydrate and sodium perborate monohydrate are of particular importance. Further bleaches which can be used are, for example, sodium percarbonate, peroxypyrophosphates, citrate perhydrates, and H₂O₂-producing peracidic salts or peracids, such as perbenzoates, peroxophthalates, diperazelaic acid, phthaloimino peracid or diperdodecanedioic acid. Cleaning agents according to the invention can also comprise bleaches from the group of organic bleaches. Typical organic bleaches are the diacyl peroxides, such as, for example, dibenzoyl peroxide. Further typical organic bleaches are the peroxyacids, particular examples being the alkyl peroxyacids and the aryl peroxyacids. Preferred representatives are (a) peroxybenzoic acid and its ring-substituted derivatives, such as alkylperoxybenzoic acids, and also peroxy-α-naphthoic acid and magnesium monoperphthalate, (b) aliphatic or substituted aliphatic peroxyacids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid) may be used.

Bleaches used in the cleaning agents according to the invention for machine dishwashing may also be substances which release chlorine or bromine. Among suitable chlorine- or bromine-releasing materials, examples include heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Bleach activators, which boost the action of the bleaches, have already been mentioned above as a possible ingredient of the rinse aid particles. Known bleach activators are compounds which contain one or more N— and/or O-acyl groups, such as substances from the class of anhydrides, esters, imides and acylated imidazoles or oximes. Examples are tetraacetylethylenediamine TAED, tetraacetylmethylenediamine TAMD and tetraacetylhexylenediamine TAHD, but also pentaacetylglycose PAG, 1,5-diacetyl-2,2-dioxohexahydro-1,3,5-triazine DADHT and isatoic anhydride ISA.

Bleach activators which may be used are compounds which, under perhydrolysis conditions, produce aliphatic peroxocarboxylic acids having preferably 1 to 10 carbon atoms, in particular 2 to 4 carbon atoms, and/or optionally substituted perbenzoic acid. Suitable substances are those which carry O-acyl and/or N-acyl groups of the stated number of carbon atoms, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran, n-methylmorpholiniumacetonitrile methylsulfate (MMA), and enol esters, and acetylated sorbitol and mannitol or mixtures thereof (SORMAN), acylated sugar derivatives, in particular pentaacetylglucose (PAG), pentaacetylfructose, tetraacetylxylose and octaacetyllactose, and acetylated, optionally N-alkylated, glucamine and gluconolactone, and/or n-acylated lactams, for example N-benzoylcaprolactam. Hydrophilically substituted acylacetals and acyllactams are likewise used with preference. Combinations of conventional bleach activators can also be used.

In addition to the conventional bleach activators, or instead of them, it is also possible to incorporate so-called bleaching catalysts into the rinse aid particles. These substances are bleach-boosting transition metal salts or transition metal complexes such as, for example, Mn—, Fe—, Co—, Ru—Mo-salen complexes or -carbonyl complexes. Mn, Fe, Co, Ru, Mo, Ti, V and Cu complexes with N-containing tripod ligands, and also Co—, Fe—, Cu— and Ru-ammine complexes can also be used as bleach catalysts.

Further bleach activators which can be used with preference for the purposes of the present application are compounds from the group of cationic nitrites, in particular cationic nitrile of the formula

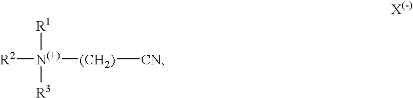

in which R¹ is —H, —CH₃, a C₂₋₂₄-alkyl or -alkenyl radical, a substituted C₂₋₂₄-alkyl or -alkenyl radical with at least one substituent from the group —Cl, —Br, —OH, —NH_{2,} —CN, an alkyl- or alkenylaryl radical with a C₁₋₂₄-alkyl group, or is a substituted alkyl- or alkenylaryl radical with a C₁₋₂₄-alkyl group and at least one further substituent on the aromatic ring, R² and R³, independently of one another, are chosen from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH where n=1, 2, 3, 4, 5, or 6 and X is an anion.

In particularly preferred agents according to the invention, a cationic nitrile of the formula

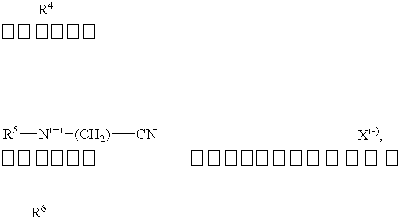

is present, in which R⁴, R⁵ and R⁶, independently of one another, are chosen from —CH₃, —CH₂—CH₃, —CH₂—CH₂—CH₃, —CH(CH₃)—CH₃, where R⁴ may additionally also be —H and X is an anion, where preferably R⁵═R⁶═—CH₃ and in particular R⁴═R⁵═R⁶═—CH₃ and compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X—, (CH₃CH(CH₃))₃N⁽⁺⁾CH₂—CN X—, or (HO—CH₂—CH₂)₃N⁽⁺⁾CH₂—CN X⁻ are particularly preferred, with particular preference from the group of these substances being given in turn to the cationic nitrile of the formula (CH₃)₃N⁽⁺⁾CH₂—CN X³¹, in which X⁻ is an anion which is chosen from the group consisting of chloride, bromide, iodide, hydrogensulfate, methosulfate, p-toluenesulfonate (tosylate) or xylenesulfonate.

Preference is given to using bleach activators from the group of polyacylated alkylenediamines, in particular tetraacetylethylenediamine (TAED), N-acylimides, in particular N-nonanoylsuccinimide (NOSI), acylated phenolsulfonates, in particular n-nonanoyl- or isononanoyloxybenzenesulfonate (n- or iso-NOBS), n-methylmorpholiniumacetonitrile methylsulfate (MMA), preferably in amounts up to 10% by weight, in particular 0. 1% by weight to 8% by weight, particularly 2 to 8% by weight and particularly preferably 2 to 6% by weight, based on the total agent.

Bleach-boosting transition metal complexes, in particular with the central atoms Mn, Fe, Co, Cu, Mo, V, Ti and/or Ru, preferably chosen from the group of manganese and/or cobalt salts and/or complexes, particularly preferably the cobalt (ammine) complexes, the cobalt (acetato) complexes, the cobalt (carbonyl) complexes, the chlorides of cobalt or manganese, and manganese sulfate are used in customary amounts, preferably in an amount up to 5% by weight, in particular from 0.0025% by weight to 1% by weight and particularly preferably from 0.01% by weight to 0.25% by weight, in each case based on the total agent. In specific cases, however, it is also possible to use a greater amount of bleach activator.

Suitable enzymes in the cleaning agents according to the invention are, in particular, those from the classes of hydrolases, such as the proteases, esterases, lipases or lipolytic enzymes, amylases, glycosyl hydrolases and mixtures of said enzymes. All of these hydrolases contribute to the removal of soilings such as proteinaceous, fatty or starchy stains. For bleaching, it is also possible to use oxidoreductases. Especially suitable enzymatic active ingredients are those obtained from bacterial strains or fungi, such as Bacillus subtilis, Bacillus licheniformis, Streptomyces griseus, Coprinus cinereus and Humicola insolens, and enzymatic active ingredients obtained from their genetically modified variants. Preference is given to using proteases of the subtilisin type and in particular proteases which are obtained from Bacillus lentus. Of particular interest here are enzyme mixtures, for example protease and amylase or protease and lipase or lipolytic enzymes, or protease, amylase and lipase or lipolytic enzymes, or protease, lipase or lipolytic enzymes, but in particular protease and/or lipase-containing mixtures or mixtures with lipolytic enzymes. Examples of such lipolytic enzymes are the known cutinases. Peroxidases or oxidases have also proven suitable in some cases. The suitable amylases include, in particular, alpha-amylases, isoamylases, pullulanases and pectinases.

The enzymes can be adsorbed to carrier substances or embedded in coating substances in order to protect them against premature decomposition. The proportion of enzymes, enzyme mixtures or enzyme granules may be, for example, from about 0.1 to 5% by weight, preferably 0.5 to about 4.5% by weight.

The use of liquid enzyme formulations is particularly preferred for the purposes of the present invention. Preference is given here to machine dishwashing detergents according to the invention which additionally comprise enzymes and/or enzyme preparations, preferably solid and/or liquid protease preparations and/or amylase preparations, in amounts of from 1 to 5% by weight, preferably from 1.5 to 4.5% by weight and in particular from 2 to 4% by weight, in each case based on the total agent.

Colorants and fragrances may be added to the machine dishwashing detergents according to the invention in order to improve the esthetic impression of the resulting products and to provide the consumer with not only the performance, but also a visually and sensorily “typical and unmistakable” product. As perfume oils and/or fragrances it is possible to use individual odorant compounds, examples being the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbonyl acetate, phenylethyl acetate, linalyl benzoate, benzyl formate, ethyl methylphenyglycinate, allyl cyclohexylpropionate, styrallyl propionate and benzyl salicylate. The ethers include, for example, benzyl ethyl ether; the aldehydes include, for example, the linear alkanals with 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol, and terpineol; the hydrocarbons include primarily the terpenes such as limonene and pinene. However, preference is given to the use of mixtures of different odorants, which together produce an appealing fragrance note. Such perfume oils may also contain natural odorant mixtures, as are obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniper berry oil, vetiver oil. olibanum oil, galbanum oil and labdanum oil, and also orange blossom oil, neroli oil, orange peel oil and sandalwood oil.

The fragrances can be incorporated directly into the cleaning agents according to the invention, although it may also be advantageous to apply the fragrances to carriers which intensify the adhesion of the perfume to the laundry and, by means of slower fragrance release, ensure long-lasting fragrance of the textiles. Materials which have become established as carriers are, for example, cyclodextrins, it being possible in addition for the cyclodextrin-perfume complexes to also be coated with further auxiliaries.

In order to improve the esthetic impression of the agents prepared according to the invention, it (or parts thereof) may be colored with suitable dyes. Preferred dyes, the selection of which presents no difficulty to the person skilled in the art, have high storage stability and insensitivity toward the other ingredients of the agents and to light and have no pronounced substantivity toward the substrates to be treated with the agents, such as glass, ceramic or plastic dishes, so as not to stain them.

In order to protect the ware or the machine, the cleaning agents according to the invention can comprise corrosion inhibitors, where particularly silver protectants are of particular importance in the field of machine dishwashing. The known substances of the prior art can be used. Generally silver protectants chosen from the group of triazoles, benzotriazoles, bisbenzotriazoles, aminotriazoles, alkylaminotriazoles and the transition metal salts or complexes can primarily be used. Benzotriazole and/or alkylaminotriazole are to be used particularly preferably. Moreover, in cleaning formulations, agents containing active chlorine which can significantly reduce corrosion of the silver surface are often found. In chlorine-free cleaners, oxygen- and nitrogen-containing organic redox-active compounds, such as di- and trihydric phenols, e.g. hydroquinone, pyrocatechol, hydroxyhydroquinone, bile acid, phloroglucine, pyrogallol and derivatives of these classes of compound are particularly. Salt- and complex-like inorganic compounds, such as salts of the metals Mn, Ti, Zr, Hf, V, Co and Ce are also often used. Preference is given here to the transition metal salts chosen from the group of manganese and/or cobalt salts and/or complexes, particularly preferably cobalt (ammine) complexes, cobalt (acetato) complexes, cobalt (carbonyl) complexes, the chlorides of cobalt or manganese, and manganese sulfate. Zinc compounds can likewise be used to prevent corrosion on the ware.

In place of or in addition to the above-described silver protectants, for example the benzotriazoles, it is also possible to use redox-active substances in the dosed washing or cleaning agent compositions according to the invention. These substances are preferably inorganic redox-active substances from the group of manganese, titanium, zirconium, hafnium, vanadium, cobalt and cerium salts and/or complexes, where the metals are preferably in one of the oxidation states II, III, IV, V or VI.

The metal salts or metal complexes used should be at least partially soluble in water. The counterions suitable for the salt formation include all customary singly, doubly or triply negatively charged inorganic anions, e.g. oxide, sulfate, nitrate, fluoride, but also organic anions, such as, for example, stearate.

Metal complexes for the purposes of the invention are compounds which consist of a central atom and one or more ligands, and optionally additionally one or more of the abovementioned anions. The central atom is one of the abovementioned metals in one of the abovementioned oxidation states. The ligands are neutral molecules or anions which are mono- or polydentate; the term “ligands” for the purposes of the invention is explained in more detail, for example, in “Römpp Chemie Lexikon, Georg Thieme Verlag, Stuttgart/New York, 9th edition, 1990, page 2507”. If, within a metal complex, the charge of the central atom and the charge of the ligand(s) do not make zero, then, depending on whether a cationic or an anionic charge excess is present, either one or more of the abovementioned anions or one or more cations, e.g. sodium, potassium, ammonium ions, ensure that the charge balances. Suitable complexing agents are, for example, citrate, acetyl acetonate or 1-hydroxyethane-1,1-diphosphonate.

The definition of “oxidation state” customary in chemistry is given, for example, in “Römpp Chemie Lexikon, Georg Thieme Verlag, Stuttgart/New York, 9th edition, 1991, page 3168”.

Particularly preferred metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃, and mixtures thereof, meaning that preferred machine dishwashing detergents according to the invention are characterized in that the metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts or metal complexes are generally standard commercial substances which can be used for the purposes of the silver corrosion protection without prior cleaning in the agents according to the invention. Thus, for example, the mixture of penta- and tetravalent vanadium (V₂O₅, VO₂, V₂O₄) known from the preparation of SO₃ (contact process) is suitable, as is the titanyl sulfate TiOSO₄ which is produced by diluting a Ti(SO₄)₂ solution.

The inorganic redox-active substances, in particular metal salts or metal complexes, are preferably coated, i.e. covered completely with a material which is water-tight, but slightly soluble at the cleaning temperatures, in order to prevent premature disintegration or oxidation during storage. Preferred coating materials, which are applied by known methods, for example melt coating method according to Sandwik from the foods industry, are paraffins, microcrystalline waxes, waxes of natural origin, such as carnauba wax, candellila wax, beeswax, higher-melting alcohols, such as, for example, hexadecanol, soaps or fatty acids. Here, the coating material, solid at room temperature, is applied to the material to be coated in the molten state, e.g. by centrifuging finely divided material to be coated in a continuous stream through a likewise continuously generated spray-mist zone of the molten coating material. The melting point must be chosen such that the coating material readily dissolves and/or rapidly melts during the silver treatment. The melting point should ideally be in the range between 45° C. An 65° C. An preferably in the range 50° C. to 60° C.

Said metal salts and/or metal complexes are present in the dosed washing or cleaning agent compositions according to the invention, in particular machine dishwashing detergents, preferably in an amount of from 0.05 to 6% by weight, preferably 0.2 to 2.5% by weight, based on the total agent.

A further important criterion for assessing a machine dishwashing detergent is, besides its cleaning performance, the optical appearance of the dry dishes after cleaning. Any calcium carbonate deposits which arise on dishes or in the inside of the machine may, for example, adversely affect customer satisfaction and thus have a causal influence on the economic success of such as cleaning agent. A further problem, which has existed for a long time, with machine dishwashing is the corrosion of glassware, which can usually be evident from the appearance of clouding, smearing and scratches, but also from an iridescence of the glass surface. The observed effects are based essentially on two operations, the emergence of alkali metal and alkaline earth metal ions from the glass in conjunction with a hydrolysis of the silicate network, secondly in deposition of silicatic compounds on the surface of the glass.

Said problems can be solved using the agents according to the invention if; in addition to the abovementioned obligatory and optional ingredients, where appropriate, certain glass corrosion inhibitors are incorporated into the agents. Preferred agents according to the invention therefore additionally comprise one or more magnesium and/or zinc salts and/or magnesium and/or zinc complexes.

A preferred class of compounds which can be added to the agents according to the invention of the parent application to prevent glass corrosion are insoluble zinc salts. These can position themselves during the dishwashing operation at the surface of the glass, where they prevent metal ions from the glass network from going into solution, and also the hydrolysis of the silicates. Additionally, these insoluble zinc salts also prevent the deposition of silicate on the surface of the glass, meaning that the glass is protected from the consequences explained above.

Insoluble zinc salts for the purposes of this preferred embodiment are zinc salts which have a solubility of at most 10 grams of zinc salt per liter of water at 20° C. Examples of insoluble zinc salts which are particularly preferred according to the invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

Said zinc compounds are used in the agents according to the invention in amounts which bring about a content of zinc ions in the agents of between 0.02 and 10% by weight, preferably between 0.1 and 5.0% by weight and in particular between 0.2 and 1.0% by weight, in each case based on the agent. The exact content of zinc salt or zinc salts in the agents is naturally dependent on the nature of the zinc salts—the less soluble the zinc salt used, the higher its concentration in the agents according to the invention.

Since the insoluble zinc salts remain largely unchanged during the dishwashing operation, the particle size of the salts is a criterion to be considered so that the salts do not adhere to glassware or parts of the machine. Preference is given here to liquid aqueous machine dishwashing detergents according to the invention in which the insoluble zinc salts have a particle size below 1.7 millimeters.

If the maximum particle size of the insoluble zinc salts is less than 1.7 mm, there is no risk of insoluble residues in the dishwasher. Preferably, the insoluble zinc salt has an average particle size which is significantly below this value in order to further minimize the risk of insoluble residues, for example an average particle size of less than 250 μm. This applies all the more the less soluble the zinc salt. In addition, the glass corrosion-inhibiting effectiveness increases with decreasing particle size. In the case of very sparingly soluble zinc salts, the average particle size is preferably below 100 μm. For even more sparingly soluble salts, it may be lower still; for example, average particle sizes below 100 μm are preferred for the very sparingly soluble zinc oxide.

A further preferred class of compounds are magnesium and/or zinc salt(s) of at least one monomeric and/or polymeric organic acid. These ensure that, even upon repeated use, the surfaces of glassware are not altered as a result of corrosion, in particular no clouding, smears or scratches, but also no iridescence of the glass surfaces, are caused.

Agents according to the invention of the parent application which comprise these substances are likewise preferred. Liquid aqueous machine dishwashing detergents which comprise one or more magnesium and/or zinc salt(s) of at least one monomeric and/or polymeric organic acid are further preferred embodiments of the present application of addition.

Although, in accordance with the invention, all magnesium and/or zinc salt(s) of monomeric and/or polymeric organic acids may be present in the claimed agents, preference is, however, as described above, given to the magnesium and/or zinc salts of monomeric and/or polymeric organic acids from the groups of unbranched saturated or unsaturated monocarboxylic acids, of branched saturated or unsaturated monocarboxylic acids, of saturated and unsaturated dicarboxylic acids, of aromatic mono-, di- and tricarboxylic acids, of sugar acids, of hydroxy acids, of oxoacids, of amino acids and/or of polymeric carboxylic acids. For the purposes of the present invention, within these groups preference is in turn given to the acids specified below:

From the group of unbranched saturated or unsaturated monocarboxylic acids: methanoic acid (formic acid), ethanoic acid (acetic acid), propanoic acid (propionic acid), pentanoic acid (valeric acid), hexanoic acid (caproic acid), heptanoic acid (enanthic acid), octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid (margarinic acid), octadecanoic acid (stearic acid), eicosanoic acid (arachidic acid), docosanoic acid (behenic acid), tetracosanoic acid (lignoceric acid), hexacosanoic acid (cerotinic acid), triacotanoic acid (melissic acid), 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid) and 9c,12c,15c-octadecatrienoic acid (linolenic acid).

From the group of branched saturated or unsaturated monocarboxylic acids: 2-methylpentanoic acid, 2-ethylhexanoic acid, 2-propylheptanoic acid, 2-butyloctanoic acid, 2-pentylnonanoic acid, 2-hexyldecanoic acid, 2-heptylundecanoic acid, 2-octyldodecanoic acid, 2-nonyltridecanoic acid, 2-decyltetradecanoic acid, 2-undecylpentadecanoic acid, 2-dodecylhexadecanoic acid, 2-tridecylheptadecanoic acid, 2-tetradecyloctadecanoic acid, 2-pentadecylnonadecanoic acid, 2-hexadecyleicosanoic acid, 2-heptadecylheneicosanoic acid.

From the group of unbranched saturated or unsaturated di- or tricarboxylic acids: propanedioic acid (malonic acid), butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), 2c-butenedioic acid (maleic acid), 2t-butenedioic acid (fumaric acid), 2-butynedicarboxylic acid (acetylenedicarboxylic acid).

From the group of aromatic mono-, di- and tricarboxylic acids: benzoic acid, 2-carboxybenzoic acid (phthalic acid), 3-carboxybenzoic acid (isophthalic acid), 4-carboxybenzoic acid (terephthalic acid), 3,4-dicarboxybenzoic acid (trimellitic acid), 3,5-dicarboxybenzoic acid (trimesionic acid).

From the group of sugar acids: galactonic acid, mannonic acid, fructonic acid, arabinonic acid, xylonic acid, ribonic acid, 2-deoxyribonic acid, alginic acid.

From the group of hydroxy acids: hydroxyphenylacetic acid (mandelic acid), 2-hydroxypropionic acid (lactic acid), hydroxysuccinic acid (malic acid), 2,3-dihydroxybutanedioic acid (tartaric acid), 2-hydroxy-1,2,3-propanetricarbonic acid (citric acid), ascorbic acid, 2-hydroxybenzoic acid (salicylic acid), 3,4,5-trihydroxybenzoic acid (gallic acid).

From the group of oxo acids: 2-oxopropionic acid (pyruvic acid), 4-oxopentanoic acid (levulinic acid).

From the group of amino acids: alanine, valine, leucine, isoleucine, proline, tryptophan, phenylalanine, methionine, glycine, serine, tyrosine, threonine, cysteine, aspargine, glutamine, aspartic acid, glutamic acid, lysine, arginine, histidine.

From the group of polymeric carboxylic acids: polyacrylic acid, polymethacrylic acid, alkylacrylamide/acrylic acid copolymers, alkylacrylamide/-methacrylic acid copolymers, alkylacrylamide/methylmethacrylic acid copolymers, copolymers of unsaturated carboxylic acids, vinyl acetate/crotonic acid copolymers, vinylpyrrolidone/vinyl acrylate copolymers.

The spectrum of the zinc salts of organic acids preferred according to the invention, preferably of organic carboxylic acids, ranges from salts which are sparingly soluble or insoluble in water, i.e. have a solubility below 100 mg/l, preferably below 10 mg/l, in particular have no solubility, to those salts which have a solubility in water above 100 mg/l, preferably above 500 mg/l, particularly preferably above 1 g/l and in particular above 5 g/l (all solubilities at 20° C. water temperature). The first group of zinc salts includes, for example, zinc citrate, zinc oleate and zinc stearate, the group of soluble zinc salts includes, for example, zinc formate, zinc acetate, zinc lactate and zinc gluconate:

In a further preferred embodiment of the present invention, the agents according to the invention comprise at least one zinc salt, but no magnesium salt of an organic acid, which is preferably at least one zinc salt of an organic carboxylic acid, particularly preferably a zinc salt from the group consisting of zinc stearate, zinc oleate, zinc gluconate, zinc acetate, zinc lactate and/or zinc citrate. Zinc ricinoleate, zinc abietate and zinc oxalate are also preferred.

An agent preferred for the purposes of the present invention comprises zinc salt in amounts of from 0.1 to 5% by weight, preferably from 0.2 to 4% by weight and in particular from 0.4 to 3% by weight, or zinc in oxidized form (calculated as Zn²⁺) in amounts of from 0.01 to 1% by weight, preferably from 0.02 to 0.5% by weight and in particular from 0.04 to 0.2% by weight, in each case based on the total weight of the machine dishwashing detergent.

The dosed washing and cleaning agent compositions according to the invention are packaged in bags made of water-soluble film. Such bag materials or films are known from the prior art and originate, for example, from the group of (acetalized) polyvinyl alcohol, polyvinylpyrrolidone, polyethylene oxide, gelatin and mixtures thereof.

Particularly preferred dosed washing or cleaning agent compositions according to the invention are characterized in that the bag made of water-soluble film comprises one or more water-soluble polymer(s), preferably a material from the group of (optionally acetalized) polyvinyl alcohol (PVAL), polyvinylpyrrolidone, polyethylene oxide, gelatin, cellulose, and derivatives thereof and mixtures thereof. “polyvinyl alcohols” (abbreviation PVAL, sometimes also PVOH) is the name for polymers of the general structure

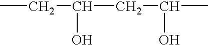

which also comprise structural units of the type

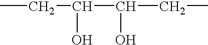

in small fractions (about 2%).

Standard commercial polyvinyl alcohols, which are supplied as white-yellowish powders or granules with degrees of polymerization in the range from about 100 to 2500 (molar masses from about 4000 to 100 000 g/mol), have degrees of hydrolysis of 98-99 or 87-89 mol %, thus also comprise a residual content of acetyl groups. The polyvinyl alcohols are characterized on the part of the manufacturer by stating the degree of polymerization of the starting polymer, the degree of hydrolysis, the hydrolysis number and the solution viscosity.

Depending on the degree of hydrolysis, polyvinyl alcohols are soluble in water and less strongly polar organic solvents (formamide, dimethylformamide, dimethyl sulfoxide); they are not attacked by (chlorinated) hydrocarbons, esters, fats and oils. Polyvinyl alcohols are classified as toxicologically safe and are at least partially biodegradable. The solubility in water can be reduced by after-treatment with aldehydes (acetalization), by complexing with Ni or Cu salts or by treatment with dichromates, boric acid or borax. The coatings made of polyvinyl alcohol are largely impenetratable for gases such as oxygen, nitrogen, helium, hydrogen, carbon dioxide, but allow steam to pass through.

For the purposes of the present invention, it is preferred for the bag to be made of water-soluble film to comprise a polyvinyl alcohol whose degree of hydrolysis is 70 to 100 mol %, preferably 80 to 90 mol %, particularly preferably 81 to 89 mol % and in particular 82 to 88 mol %.

The materials used for the bags are preferably polyvinyl alcohols with a certain molecular weight range, it being preferred according to the invention for the bags made of water-soluble film to comprise a vinyl alcohol whose molecular weight is in the range from 10 000 to 100 000 gmol⁻¹, preferably from 11 000 to 90 000 gmol⁻¹, particularly preferably from 12 000 to 80 000 gmol⁻¹ and in particular from 13 000 to 70 000 gmol⁻¹.

The degree of polymerization of such preferred polyvinyl alcohols is between approximately 200 to approximately 2100, preferably between approximately 220 to approximately 1890, particularly preferably between approximately 240 to approximately 1680 and in particular between approximately 260 to approximately 1500.

The polyvinyl alcohols described above are widely available commercially, for example under the tradename Mowiol® (Clariant). Polyvinyl alcohols which are particularly suitable for the purposes of the present invention are, for example, Mowiol® 3-83, Mowiol® 4-88, Mowiol® 5-83 and Mowiol® 8-88.

Further polyvinyl alcohols which are particularly suitable as material for the bags are given in the table below:

| | Degree of | Molar mass | Melting |
|---|---|---|---|
| Name | hydrolysis [%] | [kDa] | point [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols suitable as material for the bags are ELVANOL® 51-05, 52-22, 50-42, 85-82, 75-15, T-25, T-66, 90-50 (trade mark of Du Pont), ALCOTEX® 72.5, 78. B72, F80/40, F88/4, F88/26, F88/40, F88/47 (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11 Q, KZ-06 (trade mark of Nippon Gohsei K.K.)

The water-solubility of PVAL can be changed by after-treatment with aldehydes (acetalization) or ketones (ketalization). In this connection, polyvinyl alcohols which are acetalized or ketalized with the aldehyde or keto groups, respectively, of saccharides or polysaccharides or mixtures thereof have proven to be particularly preferred and particularly advantageous due to their exceptionally good solubility in cold water. The reaction products of PVAL and starch are to be used particularly advantageously.

Furthermore, the solubility in water can be changed by complexation with Ni or Cu salts or by treatment with dichromates, boric acid, borax, and be adjusted in a targeted manner in this way to desired values. Films of PVAL are largely impenetratable for gases such as oxygen, nitrogen, helium, hydrogen, carbon dioxide, but allow steam to pass through.

Examples of suitable water-soluble PVAL films are the PVAL films obtainable under the name “SOLUBLON®” from Syntana Handelsgesellschaft E. Harke GmbH % Co. Their solubility in water can be adjusted to a precise degree, and films of this product series are obtainable which are soluble in the aqueous phase in all temperature ranges relevant for the application.

Polyvinylpyrrolidones, referred to for short as PVP, can be described by the following general formula:

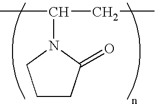

PVPs are prepared by free-radical polymerization of 1-vinylpyrrolidone. Commercially available PVPs have molar masses in the range from about 2500 to 750 000 g/mol and are supplied as white, hygroscopic powders or as aqueous solutions.

Polyethylene oxides, PEOX for short, are polyalkylene glycols of the general formula

H—[O—CH₂—CH₂]ₙ—OH

which are prepared industrially by basic-catalyzed polyaddition of ethylene oxide (oxirane) in systems containing mostly small amounts of water, with ethylene glycol as starter molecule. They have molar masses in the range from about 200 to 5 000 000 g/mol, corresponding to degrees of polymerization n of about 5 to >100 000. Polyethylene oxides have an extremely low concentration of reactive hydroxyl end groups and exhibit only weak glycol properties.

Gelatin is a polypeptide (molar mass: about 15 000 to >250 000 g/mol), which is obtained primarily by hydrolysis of the collagen present in skin and bones of animals under acidic or alkaline conditions. The amino acids composition of the gelatin corresponds largely to that of the collagen from which it has been obtained and varies depending on its provenance. The use of gelatin as water-soluble coating material is extremely widespread, particularly in pharmacy in the form of hard or soft gelatin capsules. Due to its high cost relative to the abovementioned polymers, gelatin is only used in the form of films to a small extent.

For the purposes of the present invention, preference is also given to agents according to the invention whose packaging consists of at least partially water-soluble-film of at least one polymer from the group consisting of starch and starch derivatives, cellulose and cellulose derivatives, in particular methylcellulose and mixtures thereof.

Starch is a homoglycan, the glucose units being linked (α-glycosidically. Starch is made up of two components of different molecular weight: of about 20 to 30% of straight-chain amylose (MW about 50 000 to 150 000) and 70 to 80% of branched-chain amylopectin (MW about 300 000 to 2 000 000). In addition, small amounts of lipids, phosphoric acid and cations are also present. Whereas the amyloses forms long, helical, intertwined chains with approximately 300 to 1200 glucose molecules as a result of binding in the 1,4 position, the chain branches in the case of amylopectin after, on average, 25 glucose building blocks by a 1,6 bond to give a branch-like structure with approximately 1500 to 12 000 molecules of glucose. Besides pure starch, starch derivatives which are obtainable from starch by polymer-analogous reactions are also suitable for the preparation of water-soluble coatings of the washing agent, dishwashing detergent and cleaning agent portions for the purposes of the present invention. Such chemically modified starches include, for example, products of esterifications or etherifications in which hydroxyl hydrogen atoms have been substituted. However, starches in which the hydroxyl groups have been replaced by functional groups which are not bonded via an oxygen atom can also be used as starch derivatives. The group of starch derivatives includes, for example, alkali metal starches, carboxymethyl starch (CMS), starch esters and starch ethers, and also amino starches.

Pure cellulose has the formal gross composition (C₆H₁₀O₅)ₙ and, considered formally, represents a β-1,4-polyacetal of cellobiose which, for its part, is constructed from two molecules of glucose. Suitable celluloses consist here of about 500 to 5000 glucose units and accordingly have average molar masses of from 50 000 to 500 000. Cellulose-based disintegrants which can be used for the purposes of the present invention are also cellulose derivatives, which are obtainable from cellulose by polymer-analogous reactions. Such chemically modified celluloses comprise, for example, products of esterifications or etherifications in which hydroxyl hydrogen atoms have been substituted. However, celluloses in which the hydroxy groups have been replaced by functional groups which are not bonded via an oxygen atom can also be used as cellulose derivatives. The group of cellulose derivatives includes, for example, alkali metal celluloses, carboxymethylcellulose (CMC), cellulose esters and ethers, and also aminocelluloses.

In the case of the film bags (so-called pouches) chosen according to the invention as packaging, it is preferred that the water-soluble film which forms the bag has a thickness of from 1 to 150 μm, preferably from 2 to 100 μm, particularly preferably from 5 to 75 μm and in particular from 10 to 50 μm.

These water-soluble films can be prepared by various preparation processes. In this respect, mention may in principle be made of blowing, calendering and casting processes. In a preferred process, the films are blown starting from a melt with air using an inflating mandrel to give a hose. In the calendering process, which is likewise a type of preferred preparation process, the raw materials plasticized by means of suitable additives are atomized to form the films. Here, it may in particular be necessary to follow the atomizations with a drying step. In the casting process, which is likewise a type of preferred preparation process, an aqueous polymer preparation is placed onto a heatable roller dryer, after the water has evaporated, optionally cooling is carried out and the film is taken off. Where appropriate, this film is additionally powdered prior to or whilst being taken off.

Suitable bag materials are in principle all materials which are able to completely or partially dissolve in the aqueous phase under the given conditions of a washing operation, dishwashing operation or cleaning operation (temperature, pH, concentration of washing-active components). The polymer materials may particularly preferably belong to the groups of (optionally acetalized) polyvinyl alcohol, polyvinylpyrrolidone, polyethylene oxide, gelatin, cellulose and derivatives thereof, starch and derivatives thereof, in particular modified starches, and mixtures (polymer blends, composites, coextrudates etc.) of said materials—see above. Particular preference is given to gelatin and polyvinyl alcohols, and to the two materials specified, in each case in a composite with starch or modified starch. Inorganic salts and mixtures thereof are also suitable as materials for the at least partially water-soluble coating.

According to the invention, preference is given to an embodiment according to which the bags are water-soluble as a whole, i.e. when used in accordance with the directions during washing or machine cleaning, dissolve completely when the conditions intended for dissolution are reached. An essential advantage of this embodiment is that the bags at least partially dissolve within a practically relevant short time—as a nonlimiting example a few seconds to 5 min can be specified—under precisely defined conditions in the cleaning liquor and thus, in accordance with the requirements, introduce the coated contents, i.e. the cleaning-active material or two or more materials, into the liquor.

In another embodiment of the invention, which is likewise preferred on the basis of advantageous properties, the water-soluble bag comprises areas which are less soluble or not soluble in water at all or which are only soluble in water at elevated temperature, and areas which are readily soluble in water or soluble in water at a low temperature. In other words the bags do not consist of a uniform material having the same water solubility in all areas, but of materials of differing solubility in water. In this connection, areas of good water solubility on the one hand are to be differentiated from areas with less good water solubility, with poor or even nonexistent water solubility or from areas in which the water solubility achieves the desired value only at elevated temperature or only at another pH or only at a changed electrolyte concentration, on the other hand. This may mean that, when used in accordance with the directions under adjustable conditions, certain areas of the bag dissolve whereas other areas remain intact. For example, a bag provided with pores or holes, into which water and/or liquor can penetrate, washing-active, rinse-active or cleaning-active ingredients can dissolve and discharge from the bag is formed in this way. In the same way, systems may also be envisaged in the form of multichamber bags or in the form of bags arranged inside one another (“onion system”). This allows the preparation of systems with controlled release of the washing-active, rinse-active or cleaning-active ingredients.

With regard to the formation of such systems, the invention is not subject to limitations. For example, bags may be conceived in which a uniform polymer material comprises small areas of incorporated compounds (for example of salts), which are more rapidly water-soluble than the polymer material. On the other hand, it is also possible to mix two or more polymer materials with varying solubilities in water (polymer blend), such that the more rapidly soluble polymer material is disintegrated more rapidly under defined conditions by water or the liquor than the more slowly soluble material.

It corresponds to a particularly preferred embodiment of the invention that the less readily water-soluble areas or even water-insoluble areas or areas which of the bag which are water-soluble only at elevated temperature are areas made of a material which corresponds chemically essentially to that of the readily water-soluble areas or areas which are water-soluble at a lower temperature, but has a greater layer thickness and/or has a changed degree of polymerization of the same polymer and/or has a higher degree of crosslinking of the same polymer structure and/or has a higher degree of acetalization (in the case of PVAL, for example with saccharides, polysaccharides, such as starch) and/or has a content of water-insoluble salt components and/or has a content of a water-insoluble polymer. Even taking into consideration the fact that the bags do not dissolve completely, dosed washing or cleaning agent compositions can thus be provided according to the invention which have advantageous properties upon release of the washing or cleaning agent composition into the particular liquor.

The water-soluble bag material is preferably transparent. For the purposes of this invention, transparency means that the transmittance within the visible spectrum of light (410 to 800 nm) is greater than 20%, preferably greater than 30%, particularly preferably greater than 40% and in particular greater than 50%. Thus, as soon as a wavelength of the visible spectrum of light has a transmittance greater than 20% it is to be regarded as being transparent for the purposes of the invention.

Dosed washing or cleaning agent compositions according to the invention, which are packaged in transparent bags, can comprise a stabilizing agent as essential constituent. Stabilizing agents for the purposes of the invention are materials which protect the cleaning agent constituents in their water-soluble, transparent bags against decomposition or deactivation as a result of the incidence of light. Antioxidants, UV absorbers and fluorescent dyes have proven particularly suitable here.

Particularly suitable stabilizing agents for the purposes of the invention are the antioxidants. In order to prevent undesired changes to the formulations caused by the incidence of light and thus free-radical decomposition, the formulations may comprise antioxidants. The antioxidants used here are, for example, phenols, bisphenols and thiobisphenols substituted by sterically hindered groups. Further examples are propyl gallate, butylhydroxytoluene (BHT), butylhydroxyanisole (BHA), t-butylhydroquinone (TBHQ), tocopherol and the long-chain (C8-C22) esters of gallic acid, such as dodecyl gallate. Other classes of substances are aromatic amines, preferably secondary aromatic amines and substituted p-phenylenediamines, phosphorus compounds with trivalent phosphorus, such as phosphines, phosphites and phosphonites, citric acids and citric acid derivatives, such as isopropyl citrate, compounds containing enediol groups, so-called reductones, such as ascorbic acid and its derivatives, such as ascorbic acid palmitate, organosulfur compounds, such as the esters of 3,3′-thiodipropionic acid with C₁₋₁₈-alkanols, in particular C₁₀₋₁₈-alkanols, metal ion deactivators which are able to complex the metal ions catalyzing autooxidation, such as, for example, copper, such as nitrilotriacetic acid and modifications thereof and their mixtures. Antioxidants may be present in the formulations in amounts up to 35% by weight, preferably up to 25% by weight, particularly preferably from 0.01 to 20% by weight and in particular, from 0.03 to 20% by weight.

A further class of preferably used stabilizing agents is the UV absorbers. UV absorbers can improve the photoresistance of the formulation constituents. These are understood as meaning organic substances (photoprotective filters) which are able to absorb ultraviolet rays and give off the absorbed energy again in the form of a longer-wave radiation, e.g. heat. Compounds which have these desired properties are, for example, the compounds and derivatives of benzophenone having substituents in the 2-and/or 4-position which are effective by nonradiative deactivation. Furthermore, substituted benzotriazoles, such as, for example, the water-soluble benzenesulfonic acid 3-(2H-benzotriazol-2-yl)-4-hydroxy-5-(methylpropyl)monosodium salt (Cibafast® H), acrylates phenyl-substituted in the 3-position (cinnamic acid derivatives), optionally with cyano groups in the 2-position, salicylates, organic Ni complexes, and natural substances such as umbelliferone and endogenous urocanic acid, are also suitable. Biphenyl and, in particular, stilbene derivatives, which are commercially available as Tinosorb® FD or Tinosorb® FR ex Ciba are of particular importance. UV-B absorbers to be mentioned are 3-benzylidenecamphor or 3-benzylidenenorcamphor and derivatives thereof, e.g. 3-(4-methylbenzylidene)camphor; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzo-phenone; esters of benzalmalonic acid, preferably di-2-ethylhexyl 4-methoxybenzalmalonate; triazine derivatives, such as, for example, 2,4,6-trianilino(p-carbo-2′-ethyl-1′-hexyloxy)-1,3,5-triazine and octyltriazone or dioctylbutamidotriazone (Uvisorb® HEB); propane-1,3-diones, such as, for example, 1-(4-tert-butylphenyl)-3-(4′-methoxyphenyl)propane-1,3-dione; ketotricyclo(5.2.1.0)decane derivatives. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, such as, for example, 4-(2-oxo-3-bornylidenemethyl)benzenesulfonic acid and 2-methyl-5-(2-oxo-3-bornylidene)sulfonic acid and salts thereof.

Suitable typical UV-A filters are, in particular, derivatives of benzoylmethane, such as, for example, 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds. The UV-A and UV-B filters can of course also be used in mixtures. Besides said soluble substances, suitable for this purpose are also insoluble photoprotective pigments, namely finely dispersed, preferably nanoized, metal oxides or salts. Examples of suitable metal oxides are, in particular, zinc oxide and titanium dioxide and also oxides of iron, zirconium, silicon, manganese, aluminum and cerium, and mixtures thereof.

Salts which may be used are silicates (talc), barium sulfate or zinc stearate. The oxides and salts are already used in the form of the pigments for skincare and skin-protective emulsions and decorative cosmetics. The particles should have an average diameter of less than 100 nm, preferably between 5 and 50 nm and in particular between 15 and 30 nm. They can have a spherical shape, although it is also possible to use those particles which have an ellipsoidal shape or a shape which deviates in some other way from the spherical configuration. The pigments may also be present in surface-treated form, i.e. hydrophilicized or hydrophobicized. Typical examples are coated titanium dioxide, such as, for example, titanium dioxide T 805 (Degussa) or Eusolex® T2000 (Merck). Suitable hydrophobic coating agents here are primarily silicones and specifically trialkoxyoctylsilanes or simethicones. Preference is given to using micronized zinc oxide.

UV absorbers may be present in the washing or cleaning agent compositions in amounts up to 5% by weight, preferably up to 3% by weight, particularly preferably from 0.01 to 2.0% by weight and in particular from 0.03 to 1% by weight.

A further preferably used class of stabilizing agents is the fluorescent dyes. These include the 4,4′-diamino-2,2′-stilbenedisulfonic acids (flavone acids), 4,4′-distyrylbiphenyls, methylumbelliferones, coumarins, dihydroquinolinones, 1,3-diarylpyrazolines, napthalimides, benoxazole, benzisoxazole and benzimidazole systems, and the pyrene derivatives substituted by heterocycles. Of particular importance here are the sulfonic acid salts of the diaminostilbene derivatives, and also polymeric fluorescent substances.

Fluorescent substances may be present in the formulations in amounts up to 5% by weight, preferably up to 1% by weight, particularly preferably from 0.01 to 0.5% by weight and in particular from 0.03 to 0.1% by weight.

In a preferred embodiment, the abovementioned stabilizing agents are used in any mixtures. The stabilizing agents are used in amounts up to 40% by weight, preferably up to 30% by weight, particularly preferably from 0.01 to 20% by weight, in particular from 0.02 to 5% by weight.

As already mentioned above, dosed washing or cleaning agent compositions according to the invention can be prepared such that the packaging is on the one hand water-soluble and on the other hand tightly-closing, i.e. is sealed from the surroundings. In this regard two embodiments can be realized in accordance with the invention:

For example, it corresponds to a preferred embodiment of the invention that the bag/bags is/are sealed and comprises/comprise at least one anhydrous gas which does not react with the washing or cleaning agent composition, further preferably comprises/comprise in an amount such that the overall pressure within the sealed bag(s) is greater than the external pressure, more preferably is at least one mbar above the external pressure. Very particularly preferred embodiments of these portions according to the invention comprise at least one anhydrous gas which does not react with the washing or cleaning agent composition in an amount such that the total pressure within the sealed bags is at least 5 mbar, more preferably at least 10 mbar, very particularly preferably in the range from 10 mbar to 50 mbar, above the external pressure. Very particularly, in the case of the preferred embodiments with a total pressure within the bags significantly greater than the external pressure, an ingress of moisture and/or water to the inside of the bags can surprisingly be reduced or even reliably prevented. In connection with the present invention, “external pressure” is understood as meaning the pressure which prevails on the environment side of the bags and acts on the outside of the bags, at the time of filling the bags with the particular at least one anhydrous gas.

According to the invention, the bag(s) can either comprise an anhydrous gas or can comprise two or more anhydrous gases. In practice, preference is given to supplying the bags with one gas due to the lower costs associated therewith. For the purposes of the present invention, “anhydrous” is understood as meaning that the gas/the gases are carefully dried prior to use in the portions according to the invention and thus comprise no or virtually no water any more during use; a water content approaching zero is preferred here. The drying operation can take place in a manner known to the person skilled in the art for this purpose. It is the aim that the gases as far as possible no longer contain water which could react with the components in the washing or cleaning agent compositions and could thus lead to an impairment of the quality of such components which are sensitive to moisture and/or water. Preferred washing and cleaning agent portions according to the invention comprise, as gas(es), at least one anhydrous gas which is chosen from the group consisting of N₂, noble gas(es), CO₂, N₂O, O₂, H₂, air, gaseous hydrocarbons, very particularly N₂, which is available everywhere at low cost and can be completely “dried” by methods known per se. Such gases are advantageously inert toward the components of the washing-active preparation and are therefore also sometimes referred to as “inert gases” for the purposes of the present invention.

According to a further, likewise preferred embodiment, the bag/bags is/are sealed and comprise at least-one substance, which, upon reaction with water, releases a gas which does not react with the washing-active preparation(s) in an amount such that the total pressure within the sealed bags increases. Of particular advantage are those portions in which the at least one substance present in the bag(s), upon reaction with water, releases the at least one gas in an amount such that the total pressure within the sealed bags increases by at least 1 mbar above the external pressure, preferably is greater by at least 5 mbar, particularly preferably by a value in the range from 5 to 50 mbar than the external pressure. This embodiment is of particular advantage due to the fact that their preparation is much simpler than that of the embodiment in which the gas is present in the sealed bags since only the at least one substance has to be added which, upon contact with moisture/water in the sealed bag, produces at least one gas. In addition, any moisture which penetrates into the bags is absorbed immediately by the substance capable of reacting with water and reacts and is therefore no longer available to impair the quality of the components of the washing or cleaning agent composition. Also conceivable are mixed forms of the portions in which, from the outset, both (at least) an anhydrous gas is in the bag, and a substance capable of reacting with water is present. With this embodiment, it is possible, in a particularly good and efficient way, to prevent the deterioration of the components of the agent according to the invention as a result of an ingress of moisture or water.

According to a preferred embodiment of the invention, the substance releasing a gas with water is a constituent of the washing or cleaning agent composition and is—more preferably—a hygroscopic substance which is compatible with the components of the washing or cleaning agent composition. This has the advantage, inter alia, that this substance/these substances immediately absorb/absorbs moisture or water when it ingresses into the inside of the bags to form a gas which increases the internal pressure within the bags to a value above atmospheric pressure and thus surprisingly hinders or renders impossible the ingress of further moisture and/or further water.

Examples of such substances are, without being understood as limiting, substances which are chosen from the group of substances containing bonded hydrogen peroxide, substances containing —O—O— groups, substances containing O—C—O-groups, hydrides and carbides, further preferred is a substance chosen from the group consisting of percarbonates (particularly preferably sodium percarbonate), persulfates, perborates, peracids, M_{A}M_{B}H₄, in which M_{A} is an alkali metal (particularly preferably Li or Na) (for example LiAlH₄, NaBH₄, NaAlH₄) and M_{B} is B or Al, or M₂¹C₂ or M^{II}C₂, in which M^{I} is a monovalent metal and M^{II} is a divalent metal (for example CaC₂).

Preference is given according to the invention to portions in which the anhydrous gas present in the bag(s) with which the bags are supplied directly is chosen from the group consisting of N₂, noble gas(es), CO₂, N₂O, O₂, H₂, air, gaseous hydrocarbons or mixtures thereof. A preferred gas—or at least one of the preferably used gases—is N₂, due to the fact that nitrogen is available everywhere and recoverable at low cost and can be dried using conventional agents and/or can be stored in dried form.

According to the invention, preference is likewise given to those portions in which the at least one gas formed within the bags by the substance reactive with water or moisture is chosen from the group consisting of CO₂, N₂, H₂, O₂, gaseous hydrocarbons, such as, in particular, methane, ethane, propane or a mixture of two or more of said gases. Said gases are advantageously inert toward the components of the washing-active preparation and are therefore also sometimes referred to as “inert gases” for the purposes of the present invention.

The present invention further provides a method of producing dosed liquid washing or cleaning agent compositions in which at least one solid is dispersed in at least one nonaqueous solvent and is subsequently packaged in a bag made of water-soluble film, where at least 70% by weight of the dispersed solid particles have particle sizes below 200 μm.

The solid or the solids can be dispersed in the nonaqueous liquid matrix here by stirring, shaking, beating etc., the solid in these cases already having the desired particle size prior to mixing with the solvent matrix.

Alternatively, method variants can be carried out in which the solid(s) is/are used in a coarser form. In these variants, the mixture of matrix solvent and solid is ground by wet grinding, preferably on a so-called roller mill, to the desired solid particle sizes.

With regard to the preferred particle sizes, the amounts of the individual ingredients, preferred further ingredients and preferred parameters for the bags, that stated for the agents according to the invention applies analogously for the method according to the invention.

1. A dosed liquid washing or cleaning agent composition in a bag made of water-soluble film, which has a thickness of from 2 to 100 μm, comprising a nonaqueous matrix and, dispersed therein, solid particles, characterized in that at least 70% by weight of the dispersed solid particles have particle sizes below 200 μm.

2. The dosed washing or cleaning agent composition as claimed in claim 1, characterized in that at least 70% by weight of the dispersed solid particles have particle sizes between 1 and 200 μm, preferably between 5 and 160 μm, particularly preferably between 7.5 and 120 μm and in particular between 10 and 100 μm.

3. The dosed washing or cleaning agent composition as claimed in either of claims 1 and 2, characterized in that the liquid washing or cleaning agent composition has a viscosity (Brookfield viscometer LVT-II at 20 rpm and 20° C., spindle 3) of from 500 to 50 000 mPas, preferably from 1000 to 10 000 mPas, particularly preferably from 1200 to 5000 mPas and in particular from 1300 to 3000 mPas.

4. The dosed washing or cleaning agent composition as claimed in any of claims 1 to 3, characterized in that it comprises nonaqueous solvent(s) in amounts of from 0.1 to 70% by weight, preferably from 0.5 to 60% by weight, particularly preferably from 1 to 50% by weight, very particularly preferably from 2 to 40% by weight and in particular from 2.5 to 30% by weight, in each case based on the total composition, where preferred nonaqueous solvent(s) is/are chosen from the group of nonionic surfactants which are liquid at room temperature, of polyethylene glycols and polypropylene glycols, glycerol, glycerol carbonate, triacetin, ethylene glycol, propylene glycol, propylene carbonate, hexylene glycol, ethanol, and n-propanol and/or isopropanol.

5. The dosed washing or cleaning agent composition as claimed in any of claims 1 to 4, characterized in that the dispersed solid particles comprise one or more water-soluble builders, preferably citrates and/or phosphates, preferably alkali metal phosphates, particularly preferably pentasodium or pentapotassium triphosphate (sodium or potassium tripolyphosphate), preference being given to compositions which comprise said dispersed solids in amounts of from 5 to 70% by weight, preferably from 10 to 65% by weight, particularly preferably from 15 to 60% by weight, very particularly preferably from 20 to 55% by weight and in particular from 25 to 50% by weight, in each case based on the total composition.

6. The dosed washing or cleaning agent composition as claimed in any of claims 1 to 5, characterized in that it additionally comprises 0.01 to 5% by weight, preferably 0.02 to 4% by weight, particularly preferably 0.05 to 3% by weight and in particular 0.1 to 1.5% by weight, of a thickener, preferably a polymeric thickener, preferred thickeners being hydroxyethylcellulose and/or hydroxypropylcellulose and/or thickeners from the group of polyurethanes or of modified polyacrylates, particularly preferably from thickeners of the formula XVII 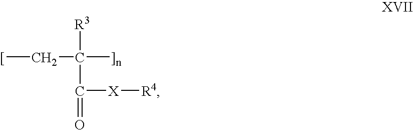
in which R³ is H or a branched or unbranched C₁₋₄-alk(en)yl radical, X is N-R⁵ or O, R⁴ is an optionally alkoxylated branched or unbranched, possibly substituted C₈₋₂₂ alk(en)yl radical, R⁵ is H or R⁴ and n is a natural number.

7. The dosed washing or cleaning agent composition as claimed in any of claims 1 to 6, characterized in that the bag made of water-soluble film comprises one or more water-soluble polymer(s), preferably a material from the group of (optionally acetalized) polyvinyl alcohol (PVAL), polyvinylpyrrolidone, polyethylene oxide, gelatin, cellulose, and derivatives thereof and mixtures thereof.

8. The dosed washing of cleaning agent composition as claimed in any of claims 1 to 7, characterized in that the bag made of water-soluble film comprises a polyvinyl alcohol whose degree of hydrolysis is 70 to 100 mol %, preferably 80 to 90 mol %, particularly preferably 81 to 89 mol % and in particular 82 to 88 mol %.

9. The dosed washing or cleaning agent composition as claimed in any of claims 1 to 8, characterized in that the bag made of water-soluble film comprises a polyvinyl alcohol whose molecular weight is in the range from 10 000 to 100 000 gmol⁻¹, preferably from 11 000 to 90 000 gmol⁻¹, particularly preferably from 12 000 to 80 000 gmol⁻¹ and in particular from 13 000 to 70 000 gmol⁻¹.

10. The dosed washing or cleaning agent composition as claimed in any of claims 1 to 9, characterized in that the water-soluble film which forms the bag has a thickness of from 5 to 75 μm and in particular from 10 to 50 μm.

11. A method of producing dosed liquid washing or cleaning agent compositions in which at least one solid is dispersed in at least one nonaqueous solvent and is subsequently packaged in a bag made of water-soluble film, which has a thickness of from 2 to 100 μm, characterized in that at least 70% by weight of the dispersed solid particles have particle sizes below 200 μm.
